(19) United States
(12) Patent Application Publication
(10) Pub. No.: US 2012/0118503 A1
(43) Pub. Date: May 17, 2012

(54) Systems and Processes for Applying Shrink Labels

(75) Inventors: James P. Lorence, Painesville, OH (US); Jeremy Bockmuller, Hiram, OH (US); Richard L. Cevera, Austinburg, OH (US); John A. Charny, Richmond Heights, OH (US); Nick McClellen, Parma, OH (US); Craig W. Potter, Mentor, OH (US); Richard A. Previty, Chardon, OH (US); Shawn Ross, Parma, OH (US); Richard W. Sheldon, Valley City, OH (US)

(73) Assignee: Avery Dennison Corporation, Pasadena, CA (US)

(21) Appl. No.: 13/384,649

(22) PCT Filed: Jul. 27, 2010
(86) PCT No.: PCT/US2010/043343

§ 371 Date: Jan. 18, 2012

Related U.S. Application Data
(60) Provisional application No. 61/228,719, filed on Jul. 27, 2009.
(60) Provisional application No. 61/296,715, filed on Jan. 20, 2010.
(60) Provisional application No. 61/299,165, filed on Jan. 28, 2010.

(51) Int. Cl. B32B 37/10; B65C 9/36; B32B 37/06; B65C 9/24; B32B 37/12

(52) U.S. Cl. 156/322; 156/580; 156/583.3; 156/60

(57) ABSTRACT

A deformable label processor and related methods are described. The processor is heated and urged against a label, such as a pressure sensitive heat shrink label, to apply the label onto a container or other surface. The processor and methods are well suited for application of labels onto compound curved surfaces. Also described are high volume label application processes using assemblies of multiple label processors. Additional assemblies and methods are described for selectively contacting and adhering regions of a label onto a moving container during labeling operations. Select regions of a label can be wiped to modify or alter label portions that are in contact and not in contact with the container. A label treatment process performed after label application is also disclosed. The treatment process reduces the occurrence of label defects and improves label retention, adherence and aesthetics. The treatment process includes heating an applied label and adhesive to a particular temperature. In particular, the heating is performed immediately after label application.

### CROSS-REFERENCE TO RELATED APPLICATIONS

The present application claims priority to U.S. Provisional Application No. 61/228,719 filed Jul. 27, 2009; U.S. Provisional Application No. 61/299,165 filed Jan. 28, 2010; and U.S. Provisional Application No. 61/296,715 filed Jan. 20, 2010, all of which are incorporated herein by reference in their entireties.

### FIELD OF THE INVENTION

The present invention relates to equipment and methods for applying shrink labels to a curved surface, and particularly to a compound curved surface. The present invention also relates to labeling processes and in particular, applying pressure sensitive heat shrink labels to containers. The present invention further relates to techniques for reducing label defects, improving label retention and label adherence, and improving aesthetics of an applied label. The invention is particularly directed to application of labels onto curved container surfaces and defect-free retention thereon.

### BACKGROUND OF THE INVENTION

It is known to apply labels to containers or bottles to provide information such as the supplier or the contents of the container. Such containers and bottles are available in a wide variety of shapes and sizes for holding many different types of materials such as detergents, chemicals, personal care products, motor oil, beverages, etc.

Polymeric film materials and film facestocks have been used as labels in various fields. Polymeric labels are increasingly desired for many applications, particularly transparent polymeric labels since they provide a no-label look to decorated glass and plastic containers. Paper labels block the visibility of the container and/or the contents in the container. Clear polymeric labels enhance the visual aesthetics of the container, and therefore the product. The popularity of polymeric labels is increasing much faster than that of paper labels in the package decoration market as consumer product companies are continuously trying to upgrade the appearance of their products. Polymeric film labels also have superior mechanical properties as compared to paper labels, such as greater tensile strength and abrasion resistance.

Traditional polymeric pressure sensitive (PSA) labels often exhibit difficulty adhering smoothly to containers having curved surfaces and/or complex shapes without wrinkling, darting or lifting on the curved surfaces. As a result, heat shrink sleeve labels have typically been used on these types of containers having compound curved surfaces. Direct screen printing is another method for applying indicia or other markings to curved surfaces. Labeling operations for sleeve type labels are carried out using processes and methods that form a tube or sleeve of the heat shrink film that is placed over the container and heated in order to shrink the film to conform to the size and shape of the container. Alternatively, the containers are completely wrapped with a shrink label using a process in which the shrink film is applied to the container directly from a continuous roll of film material and then heat is applied to conform the wrapped label to the container. Regardless, label defects frequently occur during labeling operations of simple or compound shaped bottles during label application or in post label application processes. These misapplied labels result in high scrap or extra processing steps that can be costly.

Other processes for applying pressure sensitive shrink labels are known. In certain applications, a label is applied onto a container, heated, and any resulting defects then wiped to minimize such defects. A potential problem exists with a separate heat and wipe process with pressure sensitive shrink labels where edge defects are initially formed and then removed. Although the formation of the edge defects typically occurs in the same general region of the bottle, the defects are not in the exact same spot, nor of the same size or occur in the same number. These defects, collectively referred to herein as “darts” can in certain instances, be shrunk with heat. As these defects shrink, the area of the label comprising the dart is reduced along with the ink and print on top of the label dart. The shrinkage of the dart will shrink the print as well cause distortion of the print. Depending on the size of the dart and print fidelity, the distortion might be noticed and can in certain cases, be significant. This distortion may limit the type or quality of print in the shrink region of the label. Therefore, avoiding the formation of darts entirely would be of great benefit.

Accordingly, a need exists for a process in which a shrink label could be applied to a curved surface and particularly a compound curved surface without the occurrence of darts or other defects.

Labels are typically applied to containers or other receiving surfaces by use of one or more layers of adhesive on a face of the label, the container or receiving surface, portions of label face, container or surface, or combinations of these surfaces. Prior to or during label application in which the label is contacted with the receiving surface, heating is typically employed to promote adherence of the label. In certain labeling applications, the use of heat may be necessary such as for operations utilizing heat shrink materials or using heat activated adhesives.

However, currently known labeling processes using one or more heating operations have various drawbacks. For example, in processes in which labels and/or a receiving substrate are heated to some minimum temperature prior to or during label application, the process line speed is often limited. This is due to the time required to heat the label and/or substrate to the desired temperature. Although many processes using a heating step prior to or concurrently with labeling are satisfactory, it would be beneficial to provide an alternative to such heating operations so that the label and/or substrate prior to label application, would not need to be heated or heated to the same extent, as currently known processes. By avoiding such heating operations, labeling line speeds could be increased.

Moreover, many label application processes utilize preheating stages. These stages typically include one or more heaters, conveyors, and sensing and control systems, all of which are costly, require installation and maintenance, and increase process complexity. Accordingly, it would be beneficial to eliminate such preheating stages.

Depending upon the label materials, their characteristics, and the colors and patterns appearing on the label, certain heating operations may induce non-uniform physical changes or other distortions in the label. For example, it is known that use of infrared heaters may cause uneven label shrinkage of heat shrink labels containing one or more regions of black or other dark colored regions. This is due to greater absorbance of infrared radiation by the black colored regions and thus greater heating as compared to lighter colored, translucent, or transparent regions of the label. Accordingly, it would be desirable to avoid these consequences while still using heat shrink labels having black or other dark regions.

Certain labeling equipment utilizes members that contact labels during application. These flexible members may serve to promote adherence of the label or to “wipe” the label after initial application. Typically, these members are formed from elastomers. Exposure to heat or heat inducing radiation may be detrimental to the elastomeric member. This in turn may reduce the life of the member or otherwise alter its flexibility or other desirable properties. Therefore, it would be beneficial to avoid heating prior to or during labeling operations to thereby avoid exposing such members to damaging heat or heat-inducing radiation.

Eliminating or reducing the previously noted problems may also lead to additional advantages such as reducing overall capital costs for process equipment, reducing floor space associated with a labeling process, increasing equipment life by reducing exposure to heat, and improving process consistency and reliability as a result of process simplification.

### SUMMARY OF THE INVENTION

The present invention provides advances in various phases of labeling operations. For purposes of describing the invention and its various embodiments, the invention will be described in terms of the following process phases. In a first process phase, a label is contacted and applied to a container by use of a flexible member. Alternatively, or in combination, one or more regions of the label are wiped or otherwise contacted by a moving member. And in a second process phase, the labeled containers are subjected to one or more post-heat operations.

The difficulties and drawbacks associated with previously known systems and methods are overcome in the present method and apparatus relating to a heated flexible member that readily and consistently applies pressure sensitive shrink labels to containers, and particularly containers with compound curved surfaces, without the occurrence of darts or other defects.

Regarding the first phase and using a flexible member, the present invention provides a label processor for contacting, and preferably concurrently heating and contacting, a label to a container. The processor comprises a rigid frame defining a first face and an oppositely directed second face. The frame defines an opening extending between the first and the second faces. The label processor further comprises a flexible member disposed adjacent to at least one of the first face and the second face of the frame and extending through the opening of the frame and projecting outward from the second face of the frame. The flexible member defines an outer surface for contacting a label, the flexible member also defines an interior hollow region accessible from the first face of the frame. The flexible member is deformable upon application of a label contacting force to a portion of the member projecting outward from the second face of the frame. The label processor may optionally comprise a heat source disposed within the interior hollow region of the flexible member for heating the outer surface of the flexible member.

In another aspect, the present invention provides a process for applying a label to an article. The process comprises providing a label processor including (i) a rigid frame defining a first face and an oppositely directed second face, and (ii) a flexible member projecting outward from the second face of the frame. The flexible member defines an outer surface for heating and contacting a label. The flexible member also defines an interior hollow region accessible from the first face of the frame. The process further comprises heating the outer surface of the flexible member. The process additionally comprises providing an article and a label at least partially contacted thereto, wherein portion(s) of the label contacting the article define attached region(s) and portion(s) of label free from contact with the article define unattached region(s). And, the process comprises progressively contacting the label with the heated outer surface of the flexible member such that the flexible member first contacts an attached region of the label and subsequently contacts and heats an unattached region to thereby fittingly apply the unattached region of the label to a complex curved surface of the article.

In still another aspect, the present invention provides an assembly for applying labels to a collection of containers. The assembly comprises a collection of label processors, each processor including (i) a rigid frame defining a first face and an oppositely directed second face, (ii) a flexible member projecting outward from the second face of the frame, the flexible member defining an outer surface for heating and contacting a label, the flexible member defining an interior hollow region accessible from the first face of the frame and (iii) a heat source disposed within the interior hollow region of each flexible member.

In still a further aspect, the present invention provides a label processing system for contacting a label to a container. The system comprises a label processor for concurrently heating and contacting a label to a container. The processor includes a rigid frame defining a first face and an oppositely directed second face. The frame also defines an opening extending between the first and the second faces. The label processor also includes a flexible member disposed adjacent to at least one of the first face and the second face of the frame and extending through the opening of the frame and projecting outward from the second face of the frame. The flexible member defines an outer surface for contacting a label. The flexible member defines an interior hollow region accessible from the first face of the frame. The flexible member is deformable upon application of a label contacting force to a portion of the member projecting outward from the second face of the frame. The system also comprises at least one label for heating and contacting to a container by the label processor.

The difficulties and drawbacks associated with previously known labeling techniques and associated equipment are overcome in the present systems and methods for selectively applying a label onto a moving container, and particularly a heat shrink label using pressure sensitive adhesive in which the label is initially partially contacted with the container so that label flags are produced, which can subsequently be fully adhered to the moving container.

Regarding the first phase and in the alternate strategy using a wiping member, the present invention provides an assembly for selectively contacting one or more regions of a label to a moving container. The assembly comprises a moveable frame, the frame including at least one frame member pivotally moveable about a pivot axis. The assembly also comprises a wiper member engaged to the frame member and moveable therewith, the wiper member including a wiping element for contacting a label. The assembly additionally comprises a cam follower member affixed to the frame and moveable therewith. Movement of the cam follower corresponds to movement of a container and label to be contacted by the wiping element. The wiping element selectively contacts the label to the moving container.

In another aspect, the present invention provides a system for partially applying a label to a moving container. The system comprises a conveyor for transporting containers equally spaced and aligned thereon. The system also comprises a wiping assembly disposed proximate to the conveyor. The wiping assembly includes a moveable frame, the frame pivotally moveable about a pivot axis. The wiping assembly also includes a wiper member affixed to the frame and positionable such that the wiper member can be placed into contacting proximity with a container transported by the conveyor by selectively pivoting the frame. And, the wiping assembly additionally includes a cam follower affixed to the frame and operated such that movement of the conveyor results in reciprocating pivotal movement of the cam follower, the frame, and the wiper member. The cam follower is configured such that as a container on the conveyor is transported to the wiping assembly and proximate therewith, the wiper member is positioned so as to contact a label positioned between the container and the wiper and apply a force to the label to thereby further contact the label with the container.

In another aspect, the present invention provides a labeling system for producing a labeled container. The system comprises a label dispenser adapted to selectively position a label alongside a moving container. The system also comprises a label for administration by the label dispenser. The system also comprises an assembly for selectively contacting one or more regions of a label positioned alongside a container by the label dispenser. The assembly includes a moveable frame which includes at least one frame member pivotally moveable about a pivot axis. The assembly also includes a wiper member engaged to the frame member and moveable therewith. The wiper member includes a wiping element for contacting the label. The assembly further includes a cam follower affixed to the frame and moveable therewith. Movement of the cam follower corresponds to movement of a container, such that the wiping element selectively contacts the label onto the moving container.

In yet another aspect, the present invention provides a method of selectively contacting a label to a moving container. The method comprises providing a moveable frame assembly, the frame including at least one frame member pivotally moveable about a pivot axis. The method further comprises affixing a wiper member to the frame. The method additionally comprises positioning the frame such that upon pivoting the frame about the pivot axis, the wiper member is displaced between (i) a first position in which the wiper member is in contacting proximity of a path of the moving container, and (ii) a second position in which the wiper member is spaced from the path of the moving container. The method further comprises providing a cam follower on the frame assembly. The method also comprises positioning the label between the container and the wiper member. And, the method also comprises configuring the cam follower and movement of the container such that the frame is pivoted so that when the moving container is alongside the wiper member, the wiper member is displaced to the first position so that the wiper member contacts the label to the container.

The difficulties and drawbacks associated with previously known processes and systems are overcome in the present methods and systems for various post treatment processes involving applied labels and in particular, labels applied to containers using pressure sensitive adhesives. Implementation of the methods and use of the systems described herein can reduce and in certain applications, eliminate various preheating operations otherwise required in labeling operations. The methods and systems described herein provide defect-free labeled containers or other substrates.

Regarding the second phase and in still another aspect, the present invention provides a method for preventing label post-defects. The method comprises providing a substrate having a polymeric label adhesively applied to the substrate. The method also comprises immediately after adhesive application of the label to the substrate, heating the label to a temperature sufficient to relieve at least a portion of internal stresses within the polymeric label material and thereby prevent label post-defects.

In another aspect, the present invention provides a method for improving label retention after adhesive application of the label to a substrate. The method comprises, immediately after adhesive application of a label to a substrate, heating the label and the adhesive to a temperature of at least 30° C.

In another aspect, the present invention provides a method for preventing label defects in a label applied onto a container. The method comprises providing a container having an exterior surface and providing a label. The method also comprises adhesively applying the label to the exterior surface of the container by use of an effective amount of adhesive disposed between the label and the exterior surface of the container. And, the method further comprises immediately after application of the label to the surface, heating the applied label and the adhesive to a temperature of at least 30° C. within a time period less than about 5 seconds.

In yet another aspect, the present invention provides a method for reducing label defects occurring after application of an adhesively applied label to an exterior surface of a container. The method comprises immediately after application of the label to the exterior surface of the container, heating the label and the adhesive to a temperature of from about 50° C. to about 100° C. within a time period of less than about 5 seconds.

In still another aspect, the present invention provides a system for reducing label post-defects. The system comprises an assembly for adhesively applying a label to a container. And, the system comprises one or more heaters for heating the applied label immediately after application to the container. The heaters are capable of heating the applied label from ambient to a temperature of from about 30° C. to about 150° C., within a time period of less than 5 seconds.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is an illustration of a representative container having a compound curved surface.

FIG. 2 is an illustration of the container of FIG. 1 with a label ideally applied to the outer surface of the container and extending in the region of the compound curved surface.

FIG. 3 is an illustration of the container of FIG. 1 with a label and darts as typically resulting after application to the container using currently known techniques.

FIG. 4 is a schematic perspective view of a preferred embodiment flexible member in accordance with the present invention.

FIG. 5 is a side view of the flexible member shown in FIG. 4.

FIG. 6 is a front view of the flexible member shown in FIGS. 4 and 5.

FIG. 7 is a front perspective view of the flexible member retained and supported in a preferred embodiment frame assembly and enclosure in accordance with the present invention.

FIG. 8 is another front perspective view revealing an interior region of the flexible member, frame assembly, and enclosure depicted in FIG. 7.

FIG. 9 is a rear perspective view of the flexible member, frame assembly, and enclosure of FIGS. 7 and 8.

FIG. 10 is a cross sectional view of the flexible member, frame assembly, and enclosure taken across line AA in FIG. 9.

FIG. 11 is a front view of the preferred flexible member and another preferred embodiment frame assembly in accordance with the present invention.

FIG. 12 is a perspective view of the preferred embodiment frame assembly shown in FIG. 11 without the flexible member.

FIG. 13 is a perspective view of a container having a label partially adhered to the container in accordance with a preferred method of the present invention.

FIG. 14 is a top view of the container and partially adhered label depicted in FIG. 13.

FIG. 15 is a schematic view illustrating initial contact between the label and container of FIGS. 13 and 14, with a preferred flexible member in accordance with a preferred method of the invention.

FIG. 16 is a schematic view illustrating further contact between the label and container and the flexible member, after the state shown in FIG. 15.

FIG. 17 is a schematic view illustrating further contact between the label and container and the flexible member, after the state depicted in FIG. 16.

FIG. 18 is a schematic view illustrating further contact between the label and container and the flexible member, after the state depicted in FIG. 17.

FIG. 19 is a schematic view illustrating further contact between the label and container and the flexible member, after the state shown in FIG. 18. FIG. 19 illustrates a typical rolling configuration adopted by the flexible member toward a latter stage.

FIG. 20 is a perspective view illustrating deformation of the flexible member resulting from contact with a container having a curved outer contour.

FIG. 21 is a preferred assembly of flexible members and frame assemblies for concurrently applying multiple labels onto multiple containers.

FIG. 22 is a top elevational view of a preheating assembly for use with the assembly in FIG. 21.

FIG. 23 is a top elevational view of the assembly depicted in FIG. 21 with additional components.

FIG. 24 is a schematic front view of another preferred embodiment flexible member in accordance with the invention.

FIG. 25 is a schematic front view of yet another preferred embodiment flexible member in accordance with the invention.

FIG. 26 is a front view of representative guides corresponding to the shape of a container to be labeled.

FIG. 27 is a perspective view of a preferred embodiment quick change assembly having a flexible member in accordance with the invention.

FIG. 28 is a perspective view of a collection of quick change assemblies according to the invention.

FIG. 29 is a front view of the collection of assemblies depicted in FIG. 28.

FIG. 30 is a front view of a collection of quick change assemblies, each using a different sized bladder.

FIG. 31 is a perspective view of a representative container and partially applied label.

FIG. 32 is a top planar view of the container and label depicted in FIG. 31.

FIG. 33 is a perspective view of a preferred embodiment wiping assembly in accordance with the present invention.

FIG. 34 is a perspective view of a preferred embodiment wiper member used in the wiping assembly of FIG. 33.

FIG. 35 illustrates the preferred embodiment wiping assembly applying regions of a label to a container.

FIGS. 36 and 37 schematically illustrate a configuration of a container and partially contacted label.

FIGS. 38 and 39 schematically illustrate another configuration of a container and partially contacted label.

FIGS. 40 and 41 schematically illustrate another configuration of a container and partially contacted label.

FIGS. 42-44 and 46-49 schematically depict a preferred embodiment process in accordance with the present invention.

FIG. 45 illustrates an undesirable state that can potentially occur during a labeling operation.

### DETAILED DESCRIPTION OF THE EMBODIMENTS

The present invention provides further advances in strategies, methods, components, and equipment for applying labels and films onto curved surfaces such as outer curved surfaces of various containers. Although the present invention is described in terms of applying labels or films to containers, it will be understood that the invention is not limited to containers. Instead, the invention can be used to apply a variety of labels or films onto surfaces of nearly any type of article. The invention is particularly directed to applying shrink labels onto curved container surfaces. And, the invention is also particularly directed to applying labels such as shrink labels onto compound curved surfaces of various containers.

References are made herein to containers having curved surfaces or compound curved surfaces. A curved surface is a surface defined by a line moving along a curved path. A compound curved surface is a particular type of curved surface in which the previously noted line is a curved line. Examples of a compound curved surface include, but are not limited to, the outer surface of a sphere, a hyperbolic parabloid, and a dome. It is to be understood that the present invention can be used for applying labels and films onto a wide variety of surfaces, including planar surfaces and simple curved surfaces. However, as explained in greater detail herein, the invention is particularly well suited for applying labels and films onto compound curved surfaces.

### Application of Label Using Flexible Members

Specifically, the invention provides a flexible label applicator or processor member and associated assembly that when used in accordance with a preferred technique as described herein, applies labels onto curved surfaces without attendant problems of the occurrence of defects such as darts and wrinkles. The technique results in the application of labels onto curved container surfaces without defects by using a unique concurrent heating and wiping operation.

The flexible member, its various characteristics, and various frames and related assemblies for supporting and using the member are all described in greater detail herein. Additionally, preferred aspects of labels and films for application to containers are also described herein. Moreover, preferred aspects of adhesives associated with the labels and other aspects and details of labels are described herein. Furthermore, preferred processes for applying labels by use of the flexible member(s) are all described in greater detail herein.

### Flexible Member

The present invention provides a flexible member or diaphragm that is adapted for contacting a label, label assembly, film(s), or other like components and applying pressure to the label to contact and adhere the label to a surface of a container. Typically, labels are applied to the outer surface of a container, which as previously noted, is curved or otherwise exhibits a curved contour or shape. In many instances, certain regions of the container may exhibit compound curves. By use of the present invention, labels may be applied over these regions in a defect-free manner.

The flexible member is sufficiently rigid such that the member maintains its shape prior to contact with the label(s) or container(s). The member is not overly rigid, and hence flexible, such that the member readily deforms upon contact and under application of a load, such as for example, a label contacting force. This preferred characteristic is described in greater detail herein, but generally designated by reference to the flexible member as being deformable.

The flexible member may be provided in a wide variety of different shapes, sizes, and configurations so long as it exhibits the noted deformable feature. Preferably, the flexible member defines an outwardly bulging or domed surface such as a convex surface for contacting a label and/or container. The flexible member also defines an interior hollow region, preferably accessible from a location opposite that of the outwardly bulging contact surface.

It is also preferred that the flexible member provide heat to the label and/or container. Accordingly, it is preferred that the flexible member transfer heat along at least a portion of its outer surface, and preferably along its outwardly bulging surface for subsequent transfer of such heat to a label and/or container, particularly when contacting the label. Heat may be provided along the surface of the flexible member in a variety of different ways. However, it is generally preferred that a source of heat be provided within the interior of the flexible member. Heat within the interior of the flexible member is then transmitted through a wall of the flexible member, such as by conduction, to the outer surface of the member. It will be understood that the invention includes flexible members that do not include any heating provisions. In this version of the invention, one or more preheaters are used to heat the labels and/or films.

A preferred source of heat for the flexible member is a flameless heater such as an electrically powered resistive heater. Alternatively, one or more coils of a conduit through which a heated medium is passed could also be positioned within the interior of the flexible member. Yet another source of heat is administering a heated medium directly within the hollow interior of the flexible medium. Examples of such mediums include but are not limited to air, other gases, fluids, or flowable liquids. For example, liquid hydrocarbons such as oils could be used to heat and/or fill the interior hollow region of the flexible member. However, air is often preferred since it is readily available and leakage is not a concern.

For embodiments in which a heating coil or heating unit is provided within the interior of the flexible member, the particular configuration of the coil or unit may be provided so as to optimize the transmission of heat to desired regions of the flexible member, e.g. outer peripheral regions of the region of the domed outer surface. Generally, the preferred configuration or pattern of the heater is dependent on the particular geometry of the bottle and its respective label, to which the flexible member is contacted. Preferably, an oval or circular pattern can be used, with the heater being positioned relatively close to the interior wall surface of the flexible member along regions corresponding to outer regions of the label being applied thereto. This is preferred because it is generally not necessary to heat portion(s) of the label that are already adhered to the container, e.g. the interior middle region(s). This is explained in greater detail herein.

In the preferred versions of the flexible member, the outer domed region and sometimes the sidewalls attached thereto, are flexed, deformed and moved as the member is contacted against a container and label. Thus, it is generally preferred that any heating provisions such as for example electrically resistive heating elements, not be directly attached to the flexible member. However, the present invention contemplates that such constructions and arrangements could be used. For example, flexible printed heating elements could be applied onto the inner surface or the outer surface of the flexible member. It is also contemplated that an electrically powered resistive heater could be formed within or otherwise disposed within the flexible member.

Heating of the domed label-contacting outer surface of the flexible member can be accomplished in nearly any fashion. For example, multiple heating sources, provisions, and/or other techniques may be used. In certain applications, it may be preferred to employ multiple heaters. For example, a first heater can be used to heat air entering the interior hollow region of the flexible member. The first heater can for example be an electrically powered resistive heater. A second heater can be provided within the interior of the flexible member and be relatively stationary. The second heater can be in the form of an electrically powered resistive heater or utilize one or more coils through which a heat transfer fluid flows. Heating of the flexible member is performed such that the outer temperature of the flexible member is at least 38° C. and most preferably from about 120° C. to about 150° C. during label application operations. It will be appreciated that the temperature or range of temperatures to which the outer surface of the flexible member is heated, depends upon numerous factors, including for example, the heat shrink characteristics of the label and the adhesive properties. It is also contemplated that another set of heaters could be used to heat the labels and/or the containers prior to their contact with the flexible member. These heaters can be positioned external to the flexible member. For example, one or more infrared heaters could be utilized. Infrared lamps are preferred since they tend to heat objects of interest, i.e. the labels, and do not heat the surrounding atmosphere. Preferably, for certain applications, the labels are heated to a temperature of at least 38° C. prior to their final application to a container. A wide array of heating strategies and techniques can be used in order to increase the temperature of the external surface of the flexible member.

For certain preferred embodiments, it is desirable to utilize a single heat source. That is, for certain applications it is preferred to use one or more inlet heaters to heat incoming air during or prior to its entrance into the flexible member, and not employ one or more heaters within the flexible member. Heaters provided within the interior of a flexible member are preferably radiant heaters. Elimination or avoidance of such interior heaters may provide significant cost savings. However, it will be appreciated that the invention includes systems in which heating is provided exclusively within the flexible member, systems in which heating is provided by both inlet heaters and heaters within the flexible member, and by systems using tertiary or other supplemental heaters in combination with inlet heaters and/or heaters within the interior of the flexible member.

Another feature provided in certain preferred embodiments relates to the use of one or more air manifolds generally positioned within a flexible member. In a preferred system configuration, heated air is continuously cycled through one or more flexible members during a labeling operation. Excess air is exhausted as one or more flexible members are contacted and pressed against corresponding containers carrying labels. New air is then introduced upon positioning the flexible member away from and no longer in contact with the container and label. It is preferred that the new air is heated as such practice avoids the use of ambient temperature air which would otherwise cool the flexible member.

Many of the preferred embodiment flexible member, frame, and/or enclosure assemblies utilize a single entrance for incoming heated air along a rear wall that encloses the interior of the flexible member. Directing heated air into the flexible member interior and particularly, through a single entrance, results in the creation of regions of higher temperatures along the flexible member. Such regions of non-uniformity are undesirable.

Accordingly, for certain applications, it is preferred to use an air manifold or diffuser assembly within the interior of a flexible member. The air manifolds may be in a wide array of shapes and sizes. The air manifolds serve to distribute heated air within the interior of a flexible member to thereby more uniformly heat the flexible member.

The air flow manifold or diffuser may be in a variety of different shapes, sizes, and/or configurations. For example, one or more diffuser plates may be provided against which incoming heated air is directed toward. The flowing airstream is deflected by the diffuser plate(s) and thereby directed to other regions within the interior of the flexible member. The diffuser plate can be positioned directly within the flowing air stream such as by securing the plate across the opening of an air inlet port. Other members can be used in combination with a diffuser plate such as one or more pins or other flow deflecting members. Generally, any member that induces or promotes turbulence of the air flow within the interior of a flexible member may be used.

A particularly preferred embodiment of an air manifold is a tube diffuser. A tube diffuser is preferably in the form of a pipe or conduit in flow communication with the heated air inlet and is sized and shaped so as to fit within the interior of a flexible member. The pipe or conduit defines a longitudinally extending interior flow channel. The pipe or conduit also defines a plurality of holes or other apertures in the sidewalls and any end walls of the pipe. Air entering a flexible member through the inlet is directed through the pipe and exits the pipe via the plurality of holes. The pattern or arrangement of apertures is such that the heated air exiting the pipe uniformly heats, or substantially so, the interior of the flexible member and preferably the front wall of the flexible member which ultimately contacts labels. For example, a representative pattern of apertures may include two rows of apertures extending along the length of the pipe. Each hole or aperture is approximately 1.5 mm in diameter, and spaced about 25 mm apart. The two rows are spaced 60° apart and are directed toward the inner sides and front surfaces within the interior of the flexible member. Such orientation of the rows serves to direct heated air to the lateral side regions of the flexible member where such heat is typically needed.

The interior hollow region of the flexible member may be open or in communication with the atmosphere and thus be at atmospheric pressure. Alternatively, communication between the interior region and the external atmosphere may be partially or entirely restricted, such that the interior region is at a pressure that is greater than or less than atmospheric pressure. The flexible member may also be configured or engaged with other components such that during deformation of the flexible member, the pressure within the interior hollow region of the member changes, and is different from the pressure within that region prior to deformation. For example, a preferred configuration as described in greater detail herein, provides partially restricted communication between the interior hollow region of the flexible member and the external atmosphere. Prior to deformation, the restriction is not complete so that the interior hollow region is at atmospheric pressure. Upon deformation, the volume of the interior hollow region is reduced. Due to the noted partial restriction and decrease in volume, the pressure within the interior hollow region of the flexible member increases to a pressure greater than atmospheric pressure. The increase in pressure is preferably temporary as air within the interior hollow region is allowed to exit the interior region of the flexible member. These aspects are described in greater detail herein.

Preferably, the flexible member is not pressurized prior to a label application process. That is, preferably, the interior hollow region of the flexible member is at atmospheric pressure. By selectively controlling the flow restriction of air exiting the flexible member during a label application operation, controlled increase and maintenance of pressure within the flexible member is achieved. Preferably, the contents of the flexible member are exhausted after each label application operation so that the pressure within the interior of the flexible member returns to atmospheric. Preferably, the peak pressure as measured within the interior hollow region of the flexible member is less than 34,500 N/m², more preferably less than 27,600 N/m², and most preferably less than 20,700 N/m². However, it will be understood that the present invention includes other venting strategies and the use of peak pressures lesser than or greater than these noted. Generally, over the course of a label application operation, a somewhat steady and constant inflow of air to the flexible member is provided through open exhaust ports. The flexible member will partially deflate as it contacts the label and container and in certain instances, may collapse as it fully contacts the label and container.

It will be appreciated that the present invention may utilize a wide array of assemblies in addition to or in certain applications, instead of, the flexible members described herein for applying a label or film onto a curved surface. For example, various mechanical assemblies particularly using springs or other biasing members could be used. It is also contemplated that label applicator or label processing members using compressible foams could be used.

The flexible member may be formed from nearly any material so long as the member is sufficiently flexible, i.e. deformable, and exhibits good thermal conductivity, durability, and wear properties. A preferred class of materials for the flexible member is silicones.

More precisely called polymerized siloxanes or polysiloxanes, silicones are mixed inorganic-organic polymers with the chemical formula [R₂SiO]ₙ, where R is an organic group such as methyl, ethyl, or phenyl. These materials typically include an inorganic silicon-oxygen backbone ( . . . —Si—O—Si—O—Si—O— . . . ) with organic side groups attached to the silicon atoms, which are four-coordinate.

In some cases, organic side groups can be used to link two or more of these —Si—O— backbones together. By varying the —Si—O— chain lengths, side groups, and crosslinking, silicones can be synthesized with a wide variety of properties and compositions. They can vary in consistency from liquid to gel to rubber to hard plastic. The most common siloxane is linear polydimethylsiloxane (PDMS), a silicone oil. The second largest group of silicone materials is based on silicone resins, which are formed by branched and cage-like oligosiloxanes.

A particularly preferred silicone for use in forming the flexible member is a commercially available silicone elastomer designated as Rhodorsil® V-240. Rhodorsil® V-240 is available from Bluestar Silicones of Rock Hill, S.C. This silicone elastomer is a two component, addition cure, room temperature or heat accelerated cure silicone rubber compound. It is designed as a 60 Durometer (Shore A) rubber with high strength properties, long library life, low shrinkage, excellent detail reproduction, good release characteristics, and improved resistance to inhibition. The formulation of Rhodorsil® V-240 is generally as shown in Table 1 below:

TABLE 1
Formulation of Rhodorsil ®

| Component | CAS Reg Number | Percentage |
|---|---|---|
| Methylvinylpolysiloxane | — | |
| Quartz (SᵢO₂) | 14808-60-7 | 15-40 |
| Filler | — | |
| Calcium Carbonate | 471-34-1 | 1-5 |
| Platinum Complex | — | <0.1 |

As explained herein, in certain applications, it is desirable to heat the label prior to or during application, of the label to the surface of interest. And, as previously noted, heating provisions can be incorporated within the interior hollow region of the flexible member. Accordingly, it is desirable that the material of the flexible member exhibit a relatively high thermal conductivity to promote heat transfer to the outer surface of the flexible member. Preferably, the thermal conductivity of the flexible member is at least 0.1 W/(m·° C.), more preferably at least 0.15 W/(m·° C.), more preferably at least 0.20 W/(m·° C.), more preferably at least 0.25 W/(m·° C.), and most preferably at least 0.275 W/(m·° C.).

For embodiments in which the flexible member is formed from a silicone elastomer, the thickness of the walls of the flexible member are preferably from about 2.3 mm to about 3.0 mm. It will be understood that the particular wall thickness depends upon material selection, desired deformability characteristics, and other factors. Accordingly, in no way is the present invention limited to these wall thicknesses.

Most preferably, the flexible member is a domed outwardly projecting deformable member. The member may include one or more arcuate side walls or a plurality of straight walls arranged so as to form the interior hollow region. In a preferred version, the flexible member includes four side walls that extend between a base and a domed label-contacting surface. The four walls are arranged transversely with neighboring walls so as to form a square or rectangular shape. The base is preferably in the form of a lip that extends along a common edge of the four side walls. The domed surface extends from an edge of the side walls opposite the lip. The entire flexible member, i.e. its base, side walls, and domed surface, can be readily formed by molding a silicone elastomer, such as the previously noted Rhodorsil® V-240. The exact shape, size, and configuration of the flexible member primarily depends upon the shape, size, and configuration of the bottle to which a label is to be applied. For many applications, the flexible member may be in the shape of an oval with a domed front face. However, it will be appreciated that the present invention includes flexible members of nearly any shape.

The particular shape and/or configuration of a flexible member primarily depends upon the shape of the label and the shape or contour of the container. Although for many applications, a flexible member having a generally rectangular and symmetrical frontal profile with arcuate or rounded edges may be suitable, for certain applications, it may be preferred to use flexible members having non-symmetrical frontal and/or side profiles. Examples of flexible members having non-symmetrical profiles are provided and described herein.

### Flexible Member Frame and Assembly

The present invention also provides a frame for supporting the flexible member and preferably engaging the member to facilitate positioning and contacting the member against a label and/or container. The frame is preferably rigid and may be constructed from one or more metals, polymeric materials, or composite materials exhibiting the requisite properties as more fully described herein.

Preferably, in one form, a frame having a relatively planar shape defining two oppositely directed sides and defining a relatively large central opening is provided. The opening is sized and shaped to accommodate and receive the flexible member. Accordingly, upon positioning the flexible member within the frame's opening, the frame extends about the flexible member and provides support for the member and facilitates movement or positioning of the flexible member. In a preferred embodiment, the flexible member includes a plurality of side walls. Thus, preferably, the frame defines an opening having the same shape as the plurality of side walls of the flexible member. For collections of linear side walls of a flexible member, the shape of the opening defined in the frame preferably corresponds to the shape of the collection of side walls. And, preferably, the number of linear side walls corresponds to the number of interior linear edges of the opening of the frame.

In certain applications, it may be preferred to provide one or more guides extending from the frame and generally alongside the flexible member when coupled with the frame. The one or more guide(s) are positioned and oriented relative to the flexible member such that they serve to limit the extent and/or direction of deformation of the flexible member. The guides may be affixed or otherwise formed with the frame by techniques known in the art. The guides are preferably located about the previously noted frame opening. The guides preferably extend or otherwise project from a face of the frame, and in certain embodiments, may extend transversely therefrom.

Each guide may also comprise one or more additional components or may itself extend in a desired direction relative to the flexible member. For example, an adjustably positionable secondary guide member may be provided along a distal end region of a guide. The secondary guide member may extend transverse to, or at some angle, with respect to the longitudinal axis of the guide. The position and specifically, the angular orientation of the secondary guide is preferably selectable so that a user may vary the orientation and position of the secondary guide member relative to the flexible member as desired.

Yet another preferred feature in many of the embodiments is the provision of guides having particular shapes or profiles along their inner faces, i.e. the faces of guides that are directed toward a flexible member. The use of shaped or contoured inner sides of guides promotes improved contact between flexible members and containers/labels. For certain containers having curved or sloping sidewall and/or arcuate front or rear faces, the use of guides having contoured inner sides promotes rolling contact between the flexible member and label. In addition, the provision of guides having inner sides that match or generally correspond to the contour of the container sides promotes further displacement of the flexible member around the contour of the container. Furthermore, the use of guides having inner sides that correspond to the shape of the container has also been found to promote label application of corner and outer end regions of the label to the container.

The frame is preferably formed from steel or aluminum, although a wide array of other materials are contemplated. The guides and/or the secondary guide members are also preferably formed from steel or aluminum. The guides can be integrally formed with the frame. Alternatively, the guides can be affixed to the frame after formation of the frame such as by welding or by the use of one or more fasteners. As noted, it is preferred that the secondary guide member(s) be positionable with respect to the guide(s) and/or the frame. And so, it is preferred that a selectively positionable assembly be used to releasably affix each secondary guide to a corresponding guide.

The present invention also provides an enclosure or other mounting assembly. Preferably, the frame and/or the flexible member are attached to the enclosure. The enclosure is preferably sized, shaped, and configured to be affixed to or otherwise secured to the frame. The enclosure may also serve to house heating provisions for the flexible member. These aspects are all described in greater detail herein.

Additionally, for certain embodiments it may be preferred to provide adjustment assemblies such that the position of the guides can be selectively adjusted relative to the frame. Such adjustment assemblies can be provided in many forms, however a preferred assembly includes a pair of vertically oriented rails upon which the guides can be selectively positioned and engaged. The use of such an adjustment assembly enables the vertical position of one or more guides to be readily and conveniently positioned as desired. Vertical positioning of a guide may be desirable to accommodate application of labels of different sizes and/or placement positions on the containers of interest.

The assembly of frame and enclosure, and ultimately including the flexible member, may further include one or more additional components. As previously noted, heating provisions are preferably provided within the interior hollow region of the flexible member. Preferably, such heating is provided by one or more electrically powered resistive heating element(s). The element can be in a variety of different shapes and configurations. Also, as previously noted, a conduit carrying a flowable heating medium can be positioned in the interior hollow region of the flexible member. It is generally preferred that appropriate insulating members be provided in association with the heating element to prevent direct contact with the flexible member. However, if the flexible member is formed from a material that is sufficiently resistant to high temperatures such insulating members may not be necessary.

The assembly of frame, flexible member, and enclosure preferably further includes a vent plate that extends across the open rear region of the flexible member. The vent plate provides access to the interior hollow region of the flexible member. Upon incorporation in the assembly, the vent plate contacts, and preferably sealingly contacts a rearwardly directed face of the flexible member and/or the frame. The vent plate preferably defines one or more openings extending through the vent plate that allow air to pass. Air can be introduced through these openings to pressurize the interior of the flexible member and/or to heat the flexible member. Upon deformation of the flexible member, such as after contact with a label and container, air is directed out of the hollow interior of the flexible member through the one or more openings defined in the vent plate. The total flow area of the openings of the vent plate can be selected or varied such that the rate of air exiting or entering the flexible member is limited or otherwise controlled. This strategy can be utilized to slow the rate of deformation of the flexible member. These aspects are described in greater detail herein.

In certain applications, particularly those involving high volume manufacturing, it is preferred to utilize multiple assemblies of frame(s), flexible member(s) and/or enclosure(s) such as in a parallel configuration in which the components are alongside one another.

Another optional feature of the invention is the provision of a “quick change” head assembly. In these embodiments, a releasable head assembly which carries a flexible member, optional heater(s) within the flexible member, frame, and electrical components is provided. The releasable head assembly can be readily engaged with and removed from a larger frame or support assembly, or with a walking beam apparatus as known in the art. The provision of a releasable head assembly enables fast and efficient changing of one flexible member and associated assembly for another flexible member and its associated assembly. This may be desirable when the use of a flexible member having a particular configuration is preferred over another flexible member having a different configuration. The releasable head assemblies are preferably configured such that they are easily engageable or securable to the other frame or walking beam apparatus. Electrical power and signal connections are preferably made by plug connections, although the invention includes the use of other connecting systems. These and other aspects are described in greater detail herein in conjunction with a description of a representative preferred embodiment.

### Labels/Film

The polymeric films useful in the label constructions, the application of which the present invention is directed, preferably possess balanced shrink properties. The balanced shrink properties allow the film to shrink in multiple directions to thereby follow the contour of a compound curved surface as the label is applied upon the curved surfaces. Films having unbalanced shrink, that is, films having a high degree of shrink in one direction and low to moderate shrink in the other direction, can be used. Useful films having balanced shrink allow for a wider variety of label shapes to be applied to a wider variety of container shapes. Generally, films having balanced shrink properties are preferred.

In one embodiment, the polymeric film has an ultimate shrinkage (S) as measured by ASTM procedure D1204 in at least one direction of at least 10% at 90° C. and in the other direction, the shrinkage is within the range of S +/−20%. In another embodiment, the film has an ultimate shrinkage (S) in at least one direction of about 10% to about 50% at 70° C. and in the other direction, the shrinkage is within the range of S +/−20%. In one embodiment, the ultimate shrinkage (S) is at least 10% at 90° C. and in the other direction, the shrinkage is within the range of S +/−20%. The shrink initiation temperature of the film, in one embodiment, is in the range of about 60° C. to about 80° C.

The shrink film must be thermally shrinkable and yet have sufficient stiffness to be dispensed using conventional labeling equipment and processes, including printing, die-cutting and label transfer. The stiffness of the film required depends on the size of the label, the speed of application and the labeling equipment being used. In one embodiment, the shrink film has a stiffness in the machine direction (MD) of at least 5 mN, as measured by the L&W Bending Resistance test. In one embodiment, the shrink film has a stiffness of at least 10 mN, or at least 20 mN. The stiffness of the shrink film is important for proper dispensing of labels over a peel plate at higher line speeds.

In one embodiment, die-cut labels are applied to the article or container in an automated labeling line process at a line speed of at least 30 units per minute, and preferably from at least 250 units per minute to at least 500 units per minute. It is contemplated that the present invention could be used in conjunction with processes operating as fast as 700 to 800 units per minutes, or more.

In one embodiment, the shrink film has a 2% secant modulus as measured by ASTM D882 in the machine direction (MD) of about 138,000,000 N/m² to about 2,760,000,000 N/m², and in the transverse (or cross) direction (TD) of about 138,000,000 N/m² to about 2,760,000,000 N/m². In another embodiment, the 2% secant modulus of the film is about 206,000,000 N/m² to about 2,060,000,000 N/m² in the machine direction and about 206,000,000 N/m² to about 2,060,000,000 N/m² in the transverse direction. The film may have a lower modulus in the transverse direction than in the machine direction so that the label is easily dispensed (MD) while maintaining sufficiently low modulus in the TD for conformability and/or squeezability.

The polymeric film may be made by conventional processes. For example, the film may be produced using a double bubble process, tenter process or may comprise a blown film.

The shrink film useful in the label may be a single layer construction or a multilayer construction. The layer or layers of the shrink film may be formed from a polymer chosen from polyester, polyolefin, polyvinyl chloride, polystyrene, polylactic acid, copolymers and blends thereof.

Polyolefins comprise homopolymers or copolymers of olefins that are aliphatic hydrocarbons having one or more carbon to carbon double bonds. Olefins include alkenes that comprise 1-alkenes, also known as alpha-olefins, such as 1-butene and internal alkenes having the carbon to carbon double bond on nonterminal carbon atoms of the carbon chain, such as 2-butene, cyclic olefins having one or more carbon to carbon double bonds, such as cyclohexene and norbornadiene, and cyclic polyenes which are noncyclic aliphatic hydrocarbons having two or more carbon to carbon double bonds, such as 1,4-butadiene and isoprene. Polyolefins comprise alkene homopolymers from a single alkene monomer, such as a polypropylene homopolymer, alkene copolymers from at least one alkene monomer and one or more additional olefin monomers where the first listed alkene is the major constituent of the copolymer, such as a propylene-ethylene copolymer and a propylene-ethylene-butadiene copolymer, cyclic olefin homopolymers from a single cyclic olefin monomer, and cyclic olefin copolymers from at least one cyclic olefin monomer and one or more additional olefin monomers wherein the first listed cyclic olefin is the major constituent of the copolymer, and mixtures of any of the foregoing olefin polymers.

In one embodiment, the shrink film is a multilayer film comprising a core layer and at least one skin layer. The skin layer may be a printable skin layer. In one embodiment, the multilayer shrink film comprises a core and two skin layers, wherein in at least one skin layer is printable. The multilayer shrink film may be a coextruded film.

The film can range in thickness from 12 to 500, or 12 to 300, or 12 to 200, or 25 to 75 microns. The difference in the layers of the film can include a difference in thermoplastic polymer components, in additive components, in orientation, in thickness, or a combination thereof. The thickness of the core layer can be 50 to 95%, or 60 to 95% or 70 to 90% of the thickness of the film. The thickness of a skin layer or of a combination of two skin layers can be 5 to 50%, or 5 to 40% or 10 to 30% of the thickness of the film.

The film can be further treated on one surface or both the upper and lower surfaces to enhance performance in terms of printability or adhesion to an adhesive. The treatment can comprise applying a surface coating such as, for example, a lacquer, applying a high energy discharge to include a corona discharge to a surface, applying a flame treatment to a surface, or a combination of any of the foregoing treatments. In an embodiment of the invention, the film is treated on both surfaces, and in another embodiment the film is treated on one surface with a corona discharge and is flame treated on the other surface.

The layers of the shrink film may contain pigments, fillers, stabilizers, light protective agents or other suitable modifying agents if desired. The film may also contain anti-block, slip additives and anti-static agents. Useful anti-block agents include inorganic particles, such as clays, talc, calcium carbonate and glass. Slip additives useful in the present invention include polysiloxanes, waxes, fatty amides, fatty acids, metal soaps and particulate such as silica, synthetic amorphous silica and polytetrafluoroethylene powder. Anti-static agents useful in the present invention include alkali metal sulfonates, polyether-modified polydiorganosiloxanes, polyalkylphenylsiloxanes and tertiary amines.

In one embodiment, the shrink film is microperforated to allow trapped air to be released from the interface between the label and the article to which it is adhered. In another embodiment, the shrink film is permeable to allow fluid to escape from the adhesive or from the surface of the article to escape. In one embodiment, vent holes or slits are provided in the shrink film.

The present invention can be used for applying, processing, and otherwise in association with, a wide array of labels, film, and other members. For example, the invention can be used in conjunction with shrink labels, pressure sensitive labels, pressure sensitive shrink labels, heat seal labels, and nearly any type of label or film known in the packaging and labeling arts.

### Adhesive and Additional Aspects of Labels

A description of useful pressure sensitive adhesives may be found in Encyclopedia of Polymer Science and Engineering, Vol. 13, Wiley-Interscience Publishers (New York, 1988). Additional description of useful PSAs may be found in Polymer Science and Technology, Vol. 1, Interscience Publishers (New York, 1964). Conventional PSAs, including acrylic-based PSAs, rubber-based PSAs and silicone-based PSAs are useful. The PSA may be a solvent based or may be a water based adhesive. Hot melt adhesives may also be used. In one embodiment, the PSA comprises an acrylic emulsion adhesive.

The adhesive and the side of the film to which the adhesive is applied have sufficient compatibility to enable good adhesive anchorage. In one embodiment, the adhesive is chosen so that the labels may be cleanly removed from PET containers up to 24 hours after application. The adhesive is also chosen so that the adhesive components do not migrate into the film.

In one embodiment, the adhesive may be formed from an acrylic based polymer. It is contemplated that any acrylic based polymer capable of forming an adhesive layer with sufficient tack to adhere to a substrate may function in the present invention. In certain embodiments, the acrylic polymers for the pressure sensitive adhesive layers include those formed from polymerization of at least one alkyl acrylate monomer containing from about 4 to about 12 carbon atoms in the alkyl group, and present in an amount from about 35 to 95% by weight of the polymer or copolymer, as disclosed in U.S. Pat. No. 5,264,532. Optionally, the acrylic based pressure sensitive adhesive might be formed from a single polymeric species.

The glass transition temperature of a PSA layer comprising acrylic polymers can be varied by adjusting the amount of polar, or “hard monomers”, in the copolymer, as taught by U.S. Pat. No. 5,264,532. The greater the percentage by weight of hard monomers included in an acrylic copolymer, the higher the glass transition temperature of the polymer. Hard monomers contemplated useful for the present invention include vinyl esters, carboxylic acids, and methacrylates, in concentrations by weight ranging from about 0 to about 35% by weight of the polymer.

The PSA can be acrylic based such as those taught in U.S. Pat. No. 5,164,444 (acrylic emulsion), U.S. Pat. No. 5,623,011 (tackified acrylic emulsion) and U.S. Pat. No. 6,306,982. The adhesive can also be rubber-based such as those taught in U.S. Pat. No. 5,705,551 (rubber hot melt). The adhesive can also include a radiation curable mixture of monomers with initiators and other ingredients such as those taught in U.S. Pat. No. 5,232,958 (UV cured acrylic) and U.S. Pat. No. 5,232,958 (EB cured). The disclosures of these patents as they relate to acrylic adhesives are hereby incorporated by reference.

Commercially available PSAs are useful in the invention. Examples of these adhesives include the hot melt PSAs available from H.B. Fuller Company, St. Paul, Minn. as HM-1597, HL-2207-X, HL-2115-X, HL-2193-X. Other useful commercially available PSAs include those available from Century Adhesives Corporation, Columbus, Ohio. Another useful acrylic PSA comprises a blend of emulsion polymer particles with dispersion tackifier particles as generally described in Example 2 of U.S. Pat. No. 6,306,982. The polymer is made by emulsion polymerization of 2-ethylhexyl acrylate, vinyl acetate, dioctyl maleate, and acrylic and methacrylic comonomers as described in U.S. Pat. No. 5,164,444 resulting in the latex particle size of about 0.2 microns in weight average diameters and a gel content of about 60%.

A commercial example of a hot melt adhesive is H2187-01, sold by Ato Findley, Inc., of Wauwatusa, Wis. In addition, rubber based block copolymer PSAs described in U.S. Pat. No. 3,239,478 also can be utilized in the adhesive constructions of the present invention, and this patent is hereby incorporated by a reference for its disclosure of such hot melt adhesives that are described more fully below.

In another embodiment, the pressure sensitive adhesive comprises rubber based elastomer materials containing useful rubber based elastomer materials include linear, branched, grafted, or radial block copolymers represented by the diblock structure A-B, the triblock A-B-A, the radial or coupled structures (A-B)ₙ, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may comprise from about 75% to about 95% by weight of rubbery segments and from about 5% to about 25% by weight of non-rubbery segments.

The non-rubbery segments or hard blocks comprise polymers of mono- and polycyclic aromatic hydrocarbons, and more particularly vinyl-substituted aromatic hydrocarbons that may be monocyclic or bicyclic in nature. Rubbery materials such as polyisoprene, polybutadiene, and styrene butadiene rubbers may be used to form the rubbery block or segment. Particularly useful rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

The block copolymers of vinyl aromatic hydrocarbons and conjugated dienes that may be utilized include any of those that exhibit elastomeric properties. The block copolymers may be diblock, triblock, multiblock, starblock, polyblock or graftblock copolymers. Throughout this specification, the terms diblock, triblock, multiblock, polyblock, and graft or grafted-block with respect to the structural features of block copolymers are to be given their normal meaning as defined in the literature such as in the Encyclopedia of Polymer Science and Engineering, Vol. 2, (1985) John Wiley & Sons, Inc., New York, pp. 325-326, and by J. E. McGrath in Block Copolymers, Science Technology, Dale J. Meier, Ed., Harwood Academic Publishers, 1979, at pages 1-5.

Such block copolymers may contain various ratios of conjugated dienes to vinyl aromatic hydrocarbons including those containing up to about 40% by weight of vinyl aromatic hydrocarbon. Accordingly, multi-block copolymers may be utilized which are linear or radial symmetric or asymmetric and which have structures represented by the formulae A-B, A-B-A, A-B-A-B, B-A-B, (AB)_{0,1,2 . . .} BA, etc., wherein A is a polymer block of a vinyl aromatic hydrocarbon or a conjugated diene/vinyl aromatic hydrocarbon tapered copolymer block, and B is a rubbery polymer block of a conjugated diene.

The block copolymers may be prepared by any of the well-known block polymerization or copolymerization procedures including sequential addition of monomer, incremental addition of monomer, or coupling techniques as illustrated in, for example, U.S. Pat. Nos. 3,251,905; 3,390,207; 3,598,887; and 4,219,627. As well known, tapered copolymer blocks can be incorporated in the multi-block copolymers by copolymerizing a mixture of conjugated diene and vinyl aromatic hydrocarbon monomers utilizing the difference in their copolymerization reactivity rates. Various patents describe the preparation of multi-block copolymers containing tapered copolymer blocks including U.S. Pat. Nos. 3,251,905; 3,639,521; and 4,208,356.

Conjugated dienes that may be utilized to prepare the polymers and copolymers are those containing from 4 to about 10 carbon atoms and more generally, from 4 to 6 carbon atoms. Examples include from 1,3-butadiene, 2-methyl-1,3-butadiene(isoprene), 2,3-dimethyl-1,3-butadiene, chloroprene, 1,3-pentadiene, 1,3-hexadiene, etc. Mixtures of these conjugated dienes also may be used.

Examples of vinyl aromatic hydrocarbons which may be utilized to prepare the copolymers include styrene and the various substituted styrenes such as o-methylstyrene, p-methylstyrene, p-tert-butylstyrene, 1,3-dimethylstyrene, alpha-methylstyrene, beta-methylstyrene, p-isopropylstyrene, 2,3-dimethylstyrene, o-chlorostyrene, p-chlorostyrene, o-bromostyrene, 2-chloro-4-methylstyrene, etc.

Many of the above-described copolymers of conjugated dienes and vinyl aromatic compounds are commercially available. The number average molecular weight of the block copolymers, prior to hydrogenation, is from about 20,000 to about 500,000, or from about 40,000 to about 300,000.

The average molecular weights of the individual blocks within the copolymers may vary within certain limits. In most instances, the vinyl aromatic block will have a number average molecular weight in the order of about 2000 to about 125,000, or between about 4000 and 60,000. The conjugated diene blocks either before or after hydrogenation will have number average molecular weights in the order of about 10,000 to about 450,000, or from about 35,000 to 150,000.

Also, prior to hydrogenation, the vinyl content of the conjugated diene portion generally is from about 10% to about 80%, or from about 25% to about 65%, particularly 35% to 55% when it is desired that the modified block copolymer exhibit rubbery elasticity. The vinyl content of the block copolymer can be measured by means of nuclear magnetic resonance.

Specific examples of diblock copolymers include styrene-butadiene (SB), styrene-isoprene (SI), and the hydrogenated derivatives thereof. Examples of triblock polymers include styrene-butadiene-styrene (SBS), styrene-isoprene-styrene (SIS), alpha-methylstyrene-butadiene-alpha-methylstyrene, and alpha-methylstyrene-isoprene alpha-methylstyrene. Examples of commercially available block copolymers useful as the adhesives in the present invention include those available from Kraton Polymers LLC under the KRATON trade name.

Upon hydrogenation of the SBS copolymers comprising a rubbery segment of a mixture of 1,4 and 1,2 isomers, a styrene-ethylene-butylene styrene (SEBS) block copolymer is obtained. Similarly, hydrogenation of an SIS polymer yields a styrene-ethylene propylene-styrene (SEPS) block copolymer.

The selective hydrogenation of the block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952. Such hydrogenation of the block copolymers which are carried out in a manner and to extent as to produce selectively hydrogenated copolymers having a residual unsaturation content in the polydiene block of from about 0.5% to about 20% of their original unsaturation content prior to hydrogenation.

In one embodiment, the conjugated diene portion of the block copolymer is at least 90% saturated and more often at least 95% saturated while the vinyl aromatic portion is not significantly hydrogenated. Particularly useful hydrogenated block copolymers are hydrogenated products of the block copolymers of styrene-isoprene-styrene such as a styrene-(ethylene/propylene)-styrene block polymer. When a polystyrene-polybutadiene-polystyrene block copolymer is hydrogenated, it is desirable that the 1,2-polybutadiene to 1,4-polybutadiene ratio in the polymer is from about 30:70 to about 70:30. When such a block copolymer is hydrogenated, the resulting product resembles a regular copolymer block of ethylene and 1-butene (EB). As noted above, when the conjugated diene employed as isoprene, the resulting hydrogenated product resembles a regular copolymer block of ethylene and propylene (EP).

A number of selectively hydrogenated block copolymers are available commercially from Kraton Polymers under the general trade designation “Kraton G.” One example is Kraton G1652 which is a hydrogenated SBS triblock comprising about 30% by weight of styrene end blocks and a midblock which is a copolymer of ethylene and 1-butene (EB). A lower molecular weight version of G1652 is available under the designation Kraton G1650. Kraton G1651 is another SEBS block copolymer which contains about 33% by weight of styrene. Kraton G1657 is an SEBS diblock copolymer which contains about 13% w styrene. This styrene content is lower than the styrene content in Kraton G1650 and Kraton G1652.

In another embodiment, the selectively hydrogenated block copolymer is of the formula: Bₙ(AB)ₒAₚ wherein n=0 or 1; o is 1 to 100; p is 0 or 1; each B prior to hydrogenation is predominantly a polymerized conjugated diene hydrocarbon block having a number average molecular weight of about 20,000 to about 450,000; each A is predominantly a polymerized vinyl aromatic hydrocarbon block having a number average molecular weight of from about 2000 to about 115,000; the blocks of A constituting about 5% to about 95% by weight of the copolymer; and the unsaturation of the block B is less than about 10% of the original unsaturation. In other embodiments, the unsaturation of block B is reduced upon hydrogenation to less than 5% of its original value, and the average unsaturation of the hydrogenated block copolymer is reduced to less than 20% of its original value.

The block copolymers may also include functionalized polymers such as may be obtained by reacting an alpha, beta-olefinically unsaturated monocarboxylic or dicarboxylic acid reagent onto selectively hydrogenated block copolymers of vinyl aromatic hydrocarbons and conjugated dienes as described above. The reaction of the carboxylic acid reagent in the graft block copolymer can be effected in solutions or by a melt process in the presence of a free radical initiator.

The preparation of various selectively hydrogenated block copolymers of conjugated dienes and vinyl aromatic hydrocarbons which have been grafted with a carboxylic acid reagent is described in a number of patents including U.S. Pat. Nos. 4,578,429; 4,657,970; and 4,795,782, and the disclosures of these patents relating to grafted selectively hydrogenated block copolymers of conjugated dienes and vinyl aromatic compounds, and the preparation of such compounds. U.S. Pat. No. 4,795,782 describes and gives examples of the preparation of the grafted block copolymers by the solution process and the melt process. U.S. Pat. No. 4,578,429 contains an example of grafting of Kraton G1652 (SEBS) polymer with maleic anhydride with 2,5-dimethyl-2,5-di(t-butylperoxy)hexane by a melt reaction in a twin screw extruder.

Examples of commercially available maleated selectively hydrogenated copolymers of styrene and butadiene include Kraton FG1901X, FG1921X, and FG1924X, often referred to as maleated selectively hydrogenated SEBS copolymers. FG1901X contains about 1.7% by weight bound functionality as succinic anhydride and about 28% by weight of styrene. FG1921X contains about 1% by weight of bound functionality as succinic anhydride and 29% by weight of styrene. FG1924X contains about 13% styrene and about 1% bound functionality as succinic anhydride.

Useful block copolymers also are available from Nippon Zeon Co., 2-1, Marunochi, Chiyoda-ku, Tokyo, Japan. For example, Quintac 3530 is available from Nippon Zeon and is believed to be a linear styrene-isoprene-styrene block copolymer.

Unsaturated elastomeric polymers and other polymers and copolymers which are not inherently tacky can be rendered tacky when compounded with an external tackifier. Tackifiers, are generally hydrocarbon resins, wood resins, rosins, rosin derivatives, and the like, which when present in concentrations ranging from about 40% to about 90% by weight of the total adhesive composition, or from about 45% to about 85% by weight, impart pressure sensitive adhesive characteristics to the elastomeric polymer adhesive formulation. Compositions containing less than about 40% by weight of tackifier additive do not generally show sufficient “quickstick,” or initial adhesion, to function as a pressure sensitive adhesive, and therefore are not inherently tacky. Compositions with too high a concentration of tackifying additive, on the other hand, generally show too little cohesive strength to work properly in most intended use applications of constructions made in accordance with the instant invention.

It is contemplated that any tackifier known by those of skill in the art to be compatible with elastomeric polymer compositions may be used with the present embodiment of the invention. One such tackifier, found useful is Wingtak 10, a synthetic polyterpene resin that is liquid at room temperature, and sold by the Goodyear Tire and Rubber Company of Akron, Ohio. Wingtak 95 is a synthetic tackifier resin also available from Goodyear that comprises predominantly a polymer derived from piperylene and isoprene. Other suitable tackifying additives may include Escorez 1310, an aliphatic hydrocarbon resin, and Escorez 2596, a C₅ to C₉ (aromatic modified aliphatic) resin, both manufactured by Exxon of Irving, Tex. Of course, as can be appreciated by those of skill in the art, a variety of different tackifying additives may be used to practice the present invention.

In addition to the tackifiers, other additives may be included in the PSAs to impart desired properties. For example, plasticizers may be included, and they are known to decrease the glass transition temperature of an adhesive composition containing elastomeric polymers. An example of a useful plasticizer is Shellflex 371, a naphthenic processing oil available from Shell Lubricants of Texas. Antioxidants also may be included in the adhesive compositions. Suitable antioxidants include Irgafos 168 and Irganox 565 available from Ciba-Geigy, Hawthorne, N.Y. Cutting agents such as waxes and surfactants also may be included in the adhesives.

The pressure sensitive adhesive may be applied from a solvent, emulsion or suspension, or as a hot melt. The adhesive may be applied to the inner surface of the shrink film by any known method. For example, the adhesive may be applied by die coating curtain coating, spraying, dipping, rolling, gravure or flexographic techniques. The adhesive may be applied to the shrink film in a continuous layer, a discontinuous layer or in a pattern. The pattern coated adhesive layer substantially covers the entire inner surface of the film. As used herein, “substantially covers” is intended to mean the pattern in continuous over the film surface, and is not intended to include adhesive applied only in a strip along the leading or trailing edges of the film or as a “spot weld” on the film.

In one embodiment, an adhesive deadener is applied to portions of the adhesive layer to allow the label to more readily adhere to complex shaped articles. In one embodiment, non-adhesive material such as ink dots or microbeads are applied to at least a portion of the adhesive surface to allow the adhesive layer to slide on the surface of the article as the label is being applied and/or to allow air trapped at the interface between the label and the article to escape.

A single layer of adhesive may be used or multiple adhesive layers may be used. Depending on the shrink film used and the article or container to which the label is to be applied, it may be desirable to use a first adhesive layer adjacent to the shrink film and a second adhesive layer having a different composition on the surface to be applied to the article or container for sufficient tack, peel strength and shear strength.

In one embodiment, the pressure sensitive adhesive has sufficient shear or cohesive strength to prevent excessive shrink-back of the label where adhered to the article upon the action of heat after placement of the label on the article, sufficient peel strength to prevent the film from label from lifting from the article and sufficient tack or grab to enable adequate attachment of the label to the article during the labeling operation. In one embodiment, the adhesive moves with the label as the shrink film shrinks upon the application of heat. In another embodiment, the adhesive holds the label in position so that as the shrink film shrinks, the label does not move.

The heat shrinkable film may include other layers in addition to the monolayer or multilayer heat shrinkable polymeric film. In one embodiment, a metalized coating of a thin metal film is deposited on the surface of the polymeric film. The heat shrinkable film may also include a print layer on the polymer film. The print layer may be positioned between the heat shrink layer and the adhesive layer, or the print layer may be on the outer surface of the shrink layer. In one embodiment, the film is reverse printed with a design, image or text so that the print side of the skin is in direct contact with the container to which the film is applied. In this embodiment, the film is transparent.

The labels of the present invention may also contain a layer of an ink-receptive composition that enhances the printability of the polymeric shrink layer or metal layer if present, and the quality of the print layer thus obtained. A variety of such compositions are known in the art, and these compositions generally include a binder and a pigment, such as silica or talc, dispersed in the binder. The presence of the pigment decreases the drying time of some inks. Such ink-receptive compositions are described in U.S. Pat. No. 6,153,288.

The print layer may be an ink or graphics layer, and the print layer may be a mono-colored or multi-colored print layer depending on the printed message and/or the intended pictorial design. These include variable imprinted data such as serial numbers, bar codes, trademarks, etc. The thickness of the print layer is typically in the range of about 0.5 to about 10 microns, and in one embodiment about 1 to about 5 microns, and in another embodiment about 3 microns. The inks used in the print layer include commercially available water-based, solvent-based or radiation-curable inks. Examples of these inks include Sun Sheen (a product of Sun Chemical identified as an alcohol dilutable polyamide ink), Suntex MP (a product of Sun Chemical identified as a solvent-based ink formulated for surface printing acrylic coated substrates, PVDC coated substrates and polyolefin films), X-Cel (a product of Water Ink Technologies identified as a water-based film ink for printing film substrates), Uvilith AR-109 Rubine Red (a product of Daw Ink identified as a UV ink) and CLA91598F (a product of Sun Chemical identified as a multibond black solvent-based ink).

In one embodiment, the print layer comprises a polyester/vinyl ink, a polyamide ink, an acrylic ink and/or a polyester ink. The print layer may be formed in the conventional manner by, for example, gravure, flexographic or UV flexographic printing or the like, an ink composition comprising a resin of the type described above, a suitable pigment or dye and one or more suitable volatile solvents onto one or more desired areas of the film. After application of the ink composition, the volatile solvent component(s) of the ink composition evaporate(s), leaving only the non-volatile ink components to form the print layer.

The adhesion of the ink to the surface of the polymeric shrink film or metal layer if present can be improved, if necessary, by techniques well known to those skilled in the art. For example, as mentioned above, an ink primer or other ink adhesion promoter can be applied to the metal layer or the polymeric film layer before application of the ink. Alternatively the surface of the polymeric film can be corona treated or flame treated to improve the adhesion of the ink to the polymeric film layer.

Useful ink primers may be transparent or opaque and the primers may be solvent based or water-based. In one embodiment, the primers are radiation curable (e.g., UV). The ink primer may comprise a lacquer and a diluent. The lacquer may be comprised of one or more polyolefins, polyamides, polyesters, polyester copolymers, polyurethanes, polysulfones, polyvinylidine chloride, styrene-maleic anhydride copolymers, styrene-acrylonitrile copolymers, ionomers based on sodium or zinc salts or ethylene methacrylic acid, polymethyl methacrylates, acrylic polymers and copolymers, polycarbonates, polyacrylonitriles, ethylene-vinyl acetate copolymers, and mixtures of two or more thereof. Examples of the diluents that can be used include alcohols such as ethanol, isopropanol and butanol; esters such as ethyl acetate, propyl acetate and butyl acetate; aromatic hydrocarbons such as toluene and xylene; ketones such as acetone and methyl ethyl ketone; aliphatic hydrocarbons such as heptane; and mixtures thereof. The ratio of lacquer to diluent is dependent on the viscosity required for application of the ink primer, the selection of such viscosity being within the skill of the art. The ink primer layer may have a thickness of from about 1 to about 4 microns or from about 1.5 to about 3 microns.

A transparent polymer protective topcoat or overcoat layer may be present in the labels applied in accordance with the invention. The protective topcoat or overcoat layer provide desirable properties to the label before and after the label is affixed to a substrate such as a container. The presence of a transparent topcoat layer over the print layer may, in some embodiments provide additional properties such as antistatic properties stiffness and/or weatherability, and the topcoat may protect the print layer from, e.g., weather, sun, abrasion, moisture, water, etc. The transparent topcoat layer can enhance the properties of the underlying print layer to provide a glossier and richer image. The protective transparent protective layer may also be designed to be abrasion resistant, radiation resistant (e.g, UV), chemically resistant, thermally resistant thereby protecting the label and, particularly the print layer from degradation from such causes. The protective overcoat may also contain antistatic agents, or anti-block agents to provide for easier handling when the labels are being applied to containers at high speeds. The protective layer may be applied to the print layer by techniques known to those skilled in the art. The polymer film may be deposited from a solution, applied as a preformed film (laminated to the print layer), etc.

When a transparent topcoat or overcoat layer is present, it may have a single layer or a multilayered structure. The thickness of the protective layer is generally in the range of about 12.5 to about 125 microns, and in one embodiment about 25 to about 75 microns. Examples of the topcoat layers are described in U.S. Pat. No. 6,106,982.

The protective layer may comprise polyolefins, thermoplastic polymers of ethylene and propylene, polyesters, polyurethanes, polyacryls, polymethacryls, epoxy, vinyl acetate homopolymers, co- or terpolymers, ionomers, and mixtures thereof.

The transparent protective layer may contain UV light absorbers and/or other light stabilizers. Among the UV light absorbers that are useful are the hindered amine absorbers available from Ciba Specialty Chemical under the trade designations “Tinuvin”. The light stabilizers that can be used include the hindered amine light stabilizers available from Ciba Specialty Chemical under the trade designations Tinuvin 111, Tinuvin 123, (bis-(1-octyloxy-2,2,6,6-tetramethyl-4-piperidinyl) sebacate; Tinuvin 622, (a dimethyl succinate polymer with 4-hydroxy-2,2,6,6-tetramethyl-1-piperidniethanol); Tinuvin 770 (bis-(2,2,6,6-tetramethyl-4-piperidinyl)-sebacate); and Tinuvin 783. Additional light stabilizers include the hindered amine light stabilizers available from Ciba Specialty Chemical under the trade designation “Chemassorb”, especially Chemassorb 119 and Chemassorb 944. The concentration of the UV light absorber and/or light stabilizer is in the range of up to about 2.5% by weight, and in one embodiment about 0.05% to about 1% by weight.

The transparent protective layer may contain an antioxidant. Any antioxidant useful in making thermoplastic films can be used. These include the hindered phenols and the organo phosphites. Examples include those available from Ciba Specialty Chemical under the trade designations Irganox 1010, Irganox 1076 or Irgafos 168. The concentration of the antioxidant in the thermoplastic film composition may be in the range of up to about 2.5% by weight, and in one embodiment about 0.05% to about 1% by weight.

A release liner may be adhered to the adhesive layer to protect the adhesive layer during transport, storage and handling prior to application of the label to a substrate. The liner allows for efficient handling of an array of individual labels after the labels are die cut and the matrix is stripped from the layer of facestock material and up to the point where the individual labels are dispensed in sequence on a labeling line. The release liner may have an embossed surface and/or have non-adhesive material, such as microbeads or printed ink dots, applied to the surface of the liner.

### Process for Label Application Using Flexible Member

The present invention provides a unique process in which a label is selectively and concurrently heated, shrunk, and applied onto a surface of interest, and preferably onto a compound curved surface of a container. The preferred embodiment flexible member is contacted with a label positioned between the flexible member and a surface targeted to receive the label. The domed surface of the flexible member promotes that contact between the label and the flexible member initially occur in a central region of the label, so long as the label and the flexible member are appropriately aligned. The flexible member is urged against the label, which is in contact with the surface of interest. As explained in greater detail herein, in a preferred method, prior to contact between the label and the flexible member, the label is partially in contact with and adhered to the surface of interest, at least along a central portion or region of the label. As the flexible member is urged against the label, further contact occurs between the flexible member and the label which in turn causes increasing contact area between the label and the surface of interest. The areas of contact between (i) the flexible member and the label, and (ii) the label and the surface of interest, increase over the course of label application and typically increase in an outward direction from the central portion of the label and/or the location on the label at which the domed surface of the flexible member first contacts. Greater amounts of area of the flexible member contact the label as the flexible member is further urged against the label. As will be appreciated and described in greater detail herein, the flexible member deforms and adopts the shape of the container surface to which the label is being applied. As a result, the label is fittingly applied onto the container. This feature in conjunction with the manner by which increasing contact occurs, i.e. progressively outward from a central location, is believed to be a significant factor in the resulting defect-free label application.

In addition, in accordance with another aspect of the present invention, this strategy is performed using a heated flexible member. This enables concurrent application of heat during progressive outward application of label. For applications in which the label includes a heat shrink material, such as a pressure sensitive heat shrink label, the method is preferably performed such that the label is heated and shrunk to an extent just prior to contact and adhesion with a curved surface so that the label area corresponds to the area of the surface about to receive and contact that region of the label. Any air trapped along the interface of the label and surface of interest is urged outward toward the label edge due to the progressive outward contact by the flexible member. This process is continued until the outer edges of the label are contacted and adhered to the surface of interest.

During application of a label to a container, the flexible member is contacted against the label and container. The amount of force applied to the label by the flexible member is referred to herein as a label-contacting force. Generally, that amount of force depends upon the characteristics of the label, container, and adhesive. However, typically it is preferred that the label contacting pressure be at least from about 690 N/m² to about 6900 N/m². It is to be appreciated however that the present invention includes the use of label application forces greater than or lesser than these amounts.

In accordance with the present invention, labels are applied utilizing a “center-out” strategy. Thus, contact between the flexible member and the label occurs in a center-out process also. The term “center-out” refers to the order or sequence by which regions or portions of a label are applied or contacted. First, one or more center regions of the label are contacted. Then, as that contact is maintained, one or more additional regions of the label located outward from the center or central region of the label are then contacted. This process is continued such that after contact and adherence of the label regions located outward from the center regions, that contact is maintained and one or more additional regions of the label located further outward from the previously noted regions are then contacted. This process is continued until the edge regions of the label are contacted and adhered to the container. Use of this technique ensures, or at least significantly reduces the occurrence of, air bubbles becoming trapped under the label or between the label and container.

The present invention includes the use of a wide range of cycling times. For example, in a high volume manufacturing environment, total time periods for one cycle of a flexible member and label/container being displaced toward one another, contacting, the label being adhered to the container, and the flexible member and label/container then being displaced away from another, is from about 0.5 to about 2.0 seconds, with about 0.9 seconds being preferred. The present invention includes cycle times greater than or lesser than these values.

A particularly preferred process aspect which may be utilized is referred to herein as a “double hit” operation. For certain labeling operations, it is desirable to apply labels that extend laterally around a container or at least partially so. For example, for a pair of labels that each extend or approach a 180° wrap around a container periphery, it is often difficult to achieve contact between the flexible member and the outer peripheral regions of each label. By use of a double hit strategy, greater contact can occur between a first flexible member and its label on one container face, and a second flexible member and its corresponding label on the other container face. The double hit operation uses a combination of particular stroke delay and/or stroke length of one flexible member relative to that of its opposing flexible member.

Generally, in this particular strategy for applying labels along oppositely directed faces of a container, a first label processor having a flexible member as described herein is progressively contacted with a label on a first face of the container by displacing or moving the member through a first stroke distance toward the container. A second label processor having a flexible member and generally located along an opposite side of the container is also and preferably concurrently contacted with a label on a second face of the container. The second face is generally opposite the first face. The flexible member of the second label processor is progressively contacted with the second label by displacing or moving that member through a second stroke distance toward the container. It is preferred that the first and second stroke lengths are different from one another. For the present description, the first stroke length is greater than the second stroke length. After progressive contact from the first and second flexible members, the members are withdrawn from contact with the container. Then, the process is repeated except that the stroke length of the second label processor is greater than that of the first label processor. Preferably, the stroke length of the second label processor in this second portion of the “double hit” operation is equal to the stroke length of the first label processor in the first portion of the operation.

More specifically, in a preferred double hit operation, a first flexible member on one side of a container is moved toward the container, typically in a direction transverse to the direction of a conveyor on which the container is positioned. Concurrently with movement of the first flexible member, a second flexible member on an opposite side of the container is also moved toward the container, and also in a transverse direction. However, the stroke or distance of movement of the first flexible member is greater than the stroke or distance of the opposing second flexible member. This enables the first flexible member in motion during the longer stroke to more fully wrap around the container and a first label because the second member is not blocking or otherwise hindering wrapping of the first flexible member alongside the outer regions of the container. Upon completion or full stroke of the first flexible member, both flexible members are then retracted. Upon retraction, the first and second flexible members are then again positioned toward the container. However, the second flexible member is fully extended and urged against the container and a second label, while the first flexible member undergoes the shorter stroke. Upon completion of contact between the second label and the second flexible member, the first and the second flexible members are retracted.

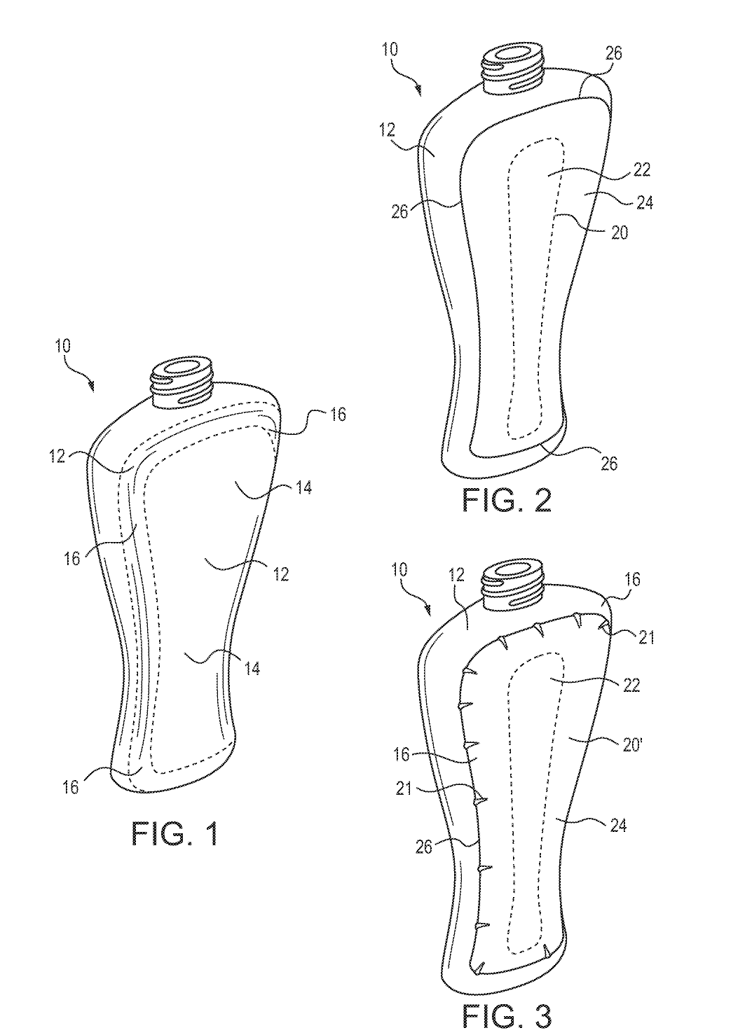

FIG. 1 illustrates a representative container 10 having one or more regions that include curved outer surfaces, and particularly one or more compound curved surfaces. The container 10 defines an outer surface 12 which includes at least one compound curved region 16. The compound curved region 16 typically extends within or along locations at which adjacent faces of the container 10 intersect or adjoin one another. Typically, one or more flat or substantially flat regions 14 are also included within the outer surface 12 of the container 10. It will be understood that the container may include few or no flat regions, such as in the case of a sphere-shaped container.

FIGS. 2 and 3 illustrate the representative container 10 depicted in FIG. 1 with a label 20 applied onto the outer surface 12 and onto at least a portion of a compound curved region 16 of the container 10. The label 20 generally defines a central region 22 and an outer edge 26 extending about the outer periphery of the label 20. The label 20 also defines one or more outer peripheral region(s) 24 extending between the central region 22 of the label and the edge 26. FIG. 2 illustrates a preferred application of the label 20 in which the label is free of darts or other defects. FIG. 3 illustrates an undesirable result and which typically occurs after applying a label to a compound curved region of a container. The label in the undesirable applied state shown in FIG. 3 is designated as 20′. The label 20′ is typically characterized by one or more darts, wrinkles, or other defects, collectively designated as 21. The darts 21 usually occur in regions of the label that overlie compound curved regions 16 of the container 10. Typically, the darts 21 and/or other defects exist in the outer region(s) 24 of the label 20. As will be appreciated, the container 10 and label 20 as applied and shown in FIG. 2 is desired. And, the state of the label 20′ containing numerous darts 21 or other defects shown in FIG. 3 is undesirable.

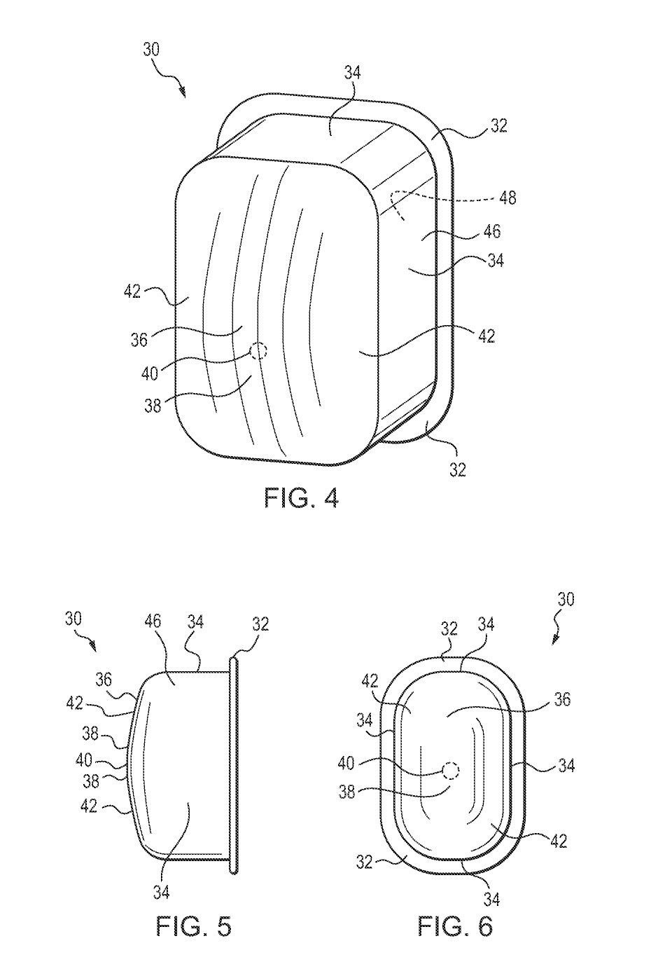

FIGS. 4 to 6 schematically illustrate a preferred embodiment flexible member 30 in accordance with the present invention. The flexible member 30 preferably comprises a base 32, a domed region 36, and one or more side walls 34 extending between the base 32 and the domed region 36. The member 30 defines an outer surface 46 and an inner surface 48. The inner surface 48 defines an interior hollow region within the flexible member 30. The interior hollow region is accessible from the rear of the flexible member and is described in greater detail herein. The flexible member 30 can also be described in terms of various regions. The domed region 36 preferably exhibits an outwardly bulging or convex contour and defines a distalmost location 40, that is a location along the outer surface 46 of the flexible member 30 that is farthest from the base 32 or the plane within which the base 32 extends. The distalmost location 40 resides within a central region 38 defined along the domed region 36, and preferably in the middle or center of the domed region 36. Extending between the central region 38 on the domed region 36 and the side walls 34, are one or more outer region(s) 42 of the domed region 36. It will be appreciated that the invention includes a wide array of flexible members having various shapes and configurations. In a preferred aspect, many of the flexible members utilize rounded or arcuate edges and corners.

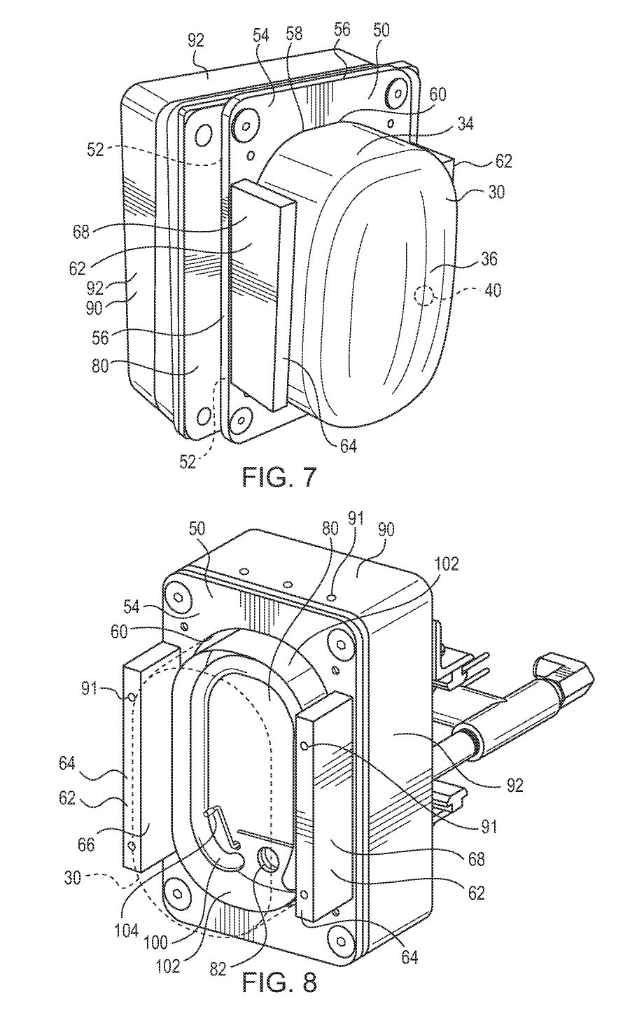

FIGS. 7 to 10 illustrate a preferred assembly of the previously described flexible member 30 retained, supported, and mounted by a frame 50 and an enclosure 90. FIG. 7 illustrates the assembly only partially assembled to reveal a vent plate 80 generally disposed rearwardly of the flexible member 30. As generally shown in FIG. 7, the frame 50 defines a rearwardly directed first face 52, a second oppositely directed, i.e. forwardly directed, second face 54, an outer edge 56 extending about the outer periphery of the frame 50 and between the faces 52 and 54, and an inner edge 58. The inner edge 58 defines an opening 60 that is preferably sized and shaped to receive the flexible member 30. In the illustrated embodiment, the opening 60 is rectangular with rounded or arcuate corners. This shape corresponds to the shape of the side walls 34 of the flexible member 30. It will be understood that the present invention includes nearly any shape for the opening 60. Preferably, the frame 50 is flat or relatively planar. The flexible member 30 is inserted through the opening 60 defined in the frame 50. Preferably, the base 32 (not shown in FIG. 7) of the flexible member 30 contacts and is disposed immediately adjacent to the first face 52 of the frame 50. And, the side walls 34 and the domed region 36 of the flexible member 30 extend through the opening 60 and outward beyond the second face 54 of the frame 50.

FIG. 7 also illustrates one or more guides 62 that are preferably provided in conjunction with the frame 50. The one or more guides 62 are preferably affixed to or otherwise formed with the frame 50 and preferably project from the second face 54 of the frame 50. The guides 62 generally define a distal edge 64, an inner wall 66 (see FIG. 8) and an oppositely directed outer wall 68. In certain applications, the guides 62 are preferably located proximate the opening 60 defined in the frame 50. In the embodiment depicted in FIGS. 7 to 8 for example, two guides 62 are utilized, arranged along opposite sides of the opening 60 defined in the frame 50. However, it will be appreciated that in numerous other applications the guides can be located elsewhere. For example, the guides may be positioned so as to distort the flexible member to a shape other than its natural or default shape. And, the guides 62 are preferably oriented parallel to each other and parallel to the longitudinal axis of the semi-rectangular shaped opening 60. FIG. 7 also illustrates that the guides 62 extend an equal distance from the second face 54 of the frame 50, and may extend from about 10% to about 100% of the distance to which the flexible member 30 extends from the second face 54. For many applications, it is preferred that the guides 62 extend to a distance as measured from the second face 54 of the frame, that is about 25% to about 75% of the distance measured between the second face 54 and the distalmost location 40 of the flexible member 30.

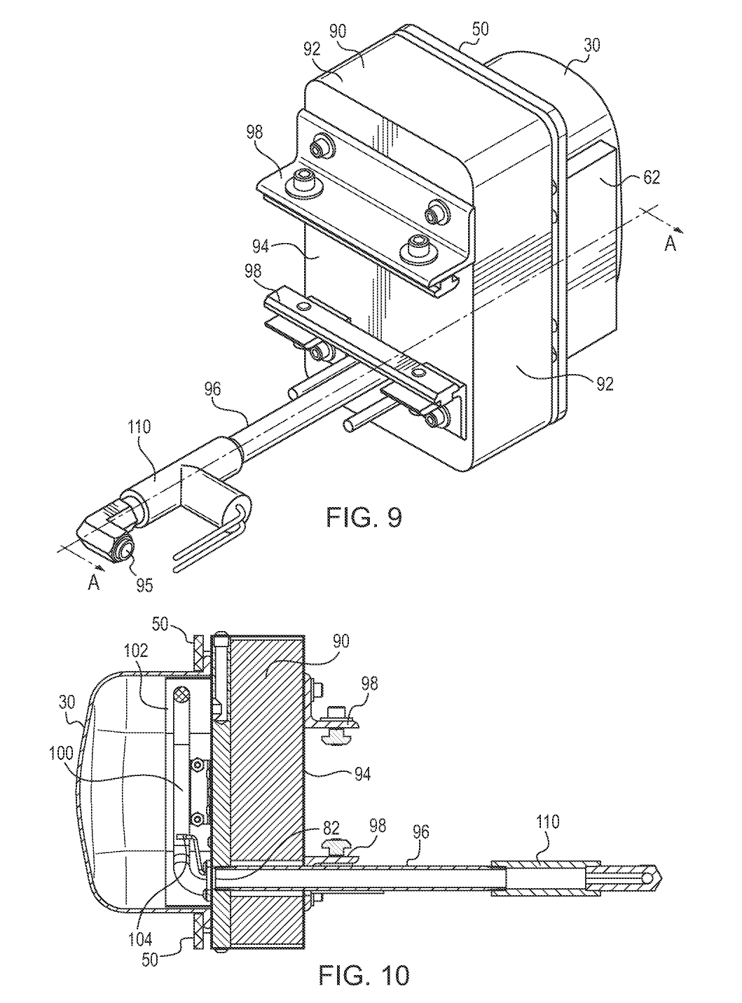

Referring to FIGS. 7 to 10 further, the assembly also includes an enclosure 90. Preferably, the enclosure 90 is a housing or other structure for mounting and retaining various components. Generally, the enclosure 90 includes one or more walls 92 and a rear wall 94. Walls 92 can include a top wall, a bottom wall, and opposing side walls. One or more conduits 96 and mounting provisions 98 can be provided, preferably along the rear of the enclosure. These aspects are described in greater detail in conjunction with FIGS. 9 and 10.

As previously noted, FIG. 7 also illustrates a vent plate 80 used in the preferred assembly. The vent plate 80 defines one or more vent passages 82 as illustrated in FIG. 8 extending through the plate 80 to allow a fluid such as air to enter and exit the interior hollow region of the flexible member 30. As shown in FIG. 7, the vent plate 80 is preferably positioned between the frame 50 and the enclosure 90.

FIG. 8 illustrates the assembly of FIG. 7 fully assembled, with the flexible member 30 shown in dashed lines thereby revealing the interior of the flexible member 30. As noted, it is preferred to provide a heat source within the flexible member 30. Accordingly, the assembly 100 includes a heater 100 preferably disposed within the interior hollow region of the flexible member 30. As previously noted, the heater can be in many different forms. For the present embodiment, the heater 100 is an electrically powered resistive heater such as a 480 volt 600 watt heater. A reflector 102 or other protective shield is preferably provided. The reflector 102 preferably extends between the heater 100 and the sidewalls 34 (not shown) of the flexible member 30. The reflector 102 may include a reflective surface to reflect radiant heat energy from the heater 100 away from an adjacent sidewall 34 of the flexible member 30. One or more temperature sensors 104 can be disposed in the interior of the flexible member 30 to obtain information as to heating and temperature conditions. FIG. 8 also illustrates a portion of the vent plate 80 and a vent passage 82 defined in the plate 80.

FIG. 8 also illustrates one or more optional apertures 91 that can be provided in the enclosure 90, in the guides 62, or both, or in other components. The apertures 91 may be provided to allow for circulation of air from inside of the enclosure 90 to one or more regions external to and along the outer surface of the flexible member 30. The optional apertures 91 may serve to promote heating of the outer surface of the flexible member as a result of relatively hot air exiting the enclosure 90 and being directed toward or at least alongside the flexible member 30.

FIGS. 9 and 10 illustrate additional components and provisions of the preferred assembly of the flexible member 30, the frame 50, and the enclosure 90. One or more conduits 96 preferably extend from the rear wall 94 of the enclosure 90 and serve to direct air or other fluid into the interior of the flexible member 30. Air, typically under pressure, is directed into an entrance 95 defined in the conduit 96. Air flowing through the conduit 96 enters the interior hollow region of the flexible member 30 through the vent passage 82.

A preheater 110 can be provided such as inline or otherwise in flow communication with the conduit 96. The heater 110 serves to heat air or other fluid entering the conduit 96 to lessen the heating burden otherwise imposed upon the heater 100 disposed within the flexible member 30. It will be understood that the preheater 110 may include an integral section or portion of conduit. Although a wide array of heating devices and strategies can be used for the preheater 110, a preferred heater is an electrically powered resistive heater such as a 170 volt 1,600 watt heater available from Sylvania of Exeter, N.H.

With further reference to FIGS. 9 and 10, it is also preferred to provide one or more mounting provisions 98 on the enclosure, such as along the rear wall 94 of the enclosure 90. The mounting provisions 98 enable convenient and secure affixment of the enclosure 90 including the flexible member 30 to one or more support members.

FIG. 10 is a cross sectional view of the flexible member 30, frame 50, enclosure 90, and conduit 96 taken across line AA in FIG. 9. FIG. 10 illustrates a preferred configuration for the heaters 100 and 110, and the conduit 96 for administering air into and out of the hollow interior of the flexible member 30, through one or more vent passages 82. It will be appreciated that a single vent passage 82 may be used for providing communication between the interior of the flexible member 30 and the conduit 96. Thus, air entering the flexible member 30 travels through the conduit 96 and through the vent passage 82. The present invention also includes an air flow configuration in which air enters the flexible member 30 through the conduit 96 and the vent passage 82, and exits the flexible member through one or more other vent passages (not expressly identified in FIG. 10) provided in the vent plate 80 and/or the enclosure 90.

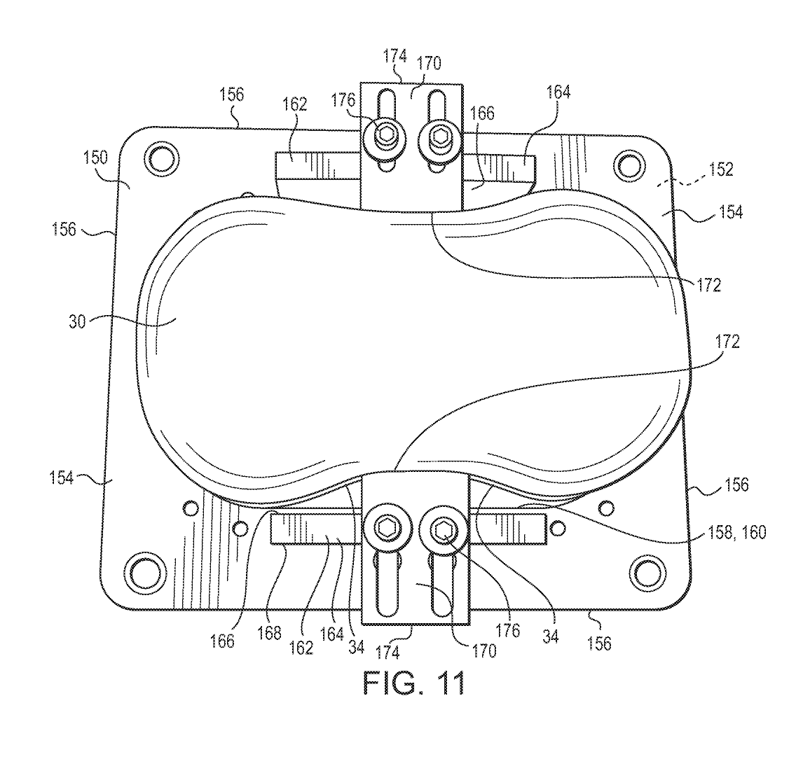

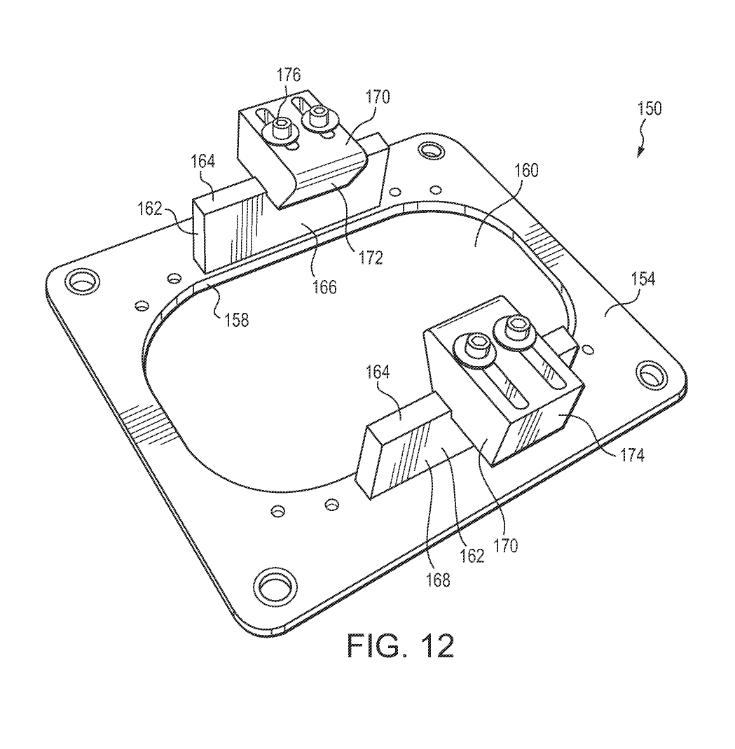

FIGS. 11 and 12 illustrate another preferred embodiment frame 150. FIG. 11 shows the frame 150 in assembled relation with a flexible member 30, and FIG. 12 illustrates the frame 150 by itself. The frame 150 defines a first face 152, a second oppositely directed face 154, an outer edge 156, and an inner edge 158. The inner edge 158 defines an opening 160 sized and shaped to engage and receive a flexible member 30. The frame 150 includes two guides 162 extending from the second face 154 of the frame 150. Each guide 162 defines a distal edge 164, an inner wall 166, and an oppositely directed outer wall 168. Preferably disposed along a distal region of each guide 162, is a secondary guide 170 or wing member. The secondary guide 170 preferably extends at some angle with respect to its corresponding guide 162. Each secondary guide 170 defines an inner end 172 and an opposite outer end 174. Each secondary guide 170 is preferably releasably secured to a corresponding guide 162 such that the position of the secondary guide 170 can be selectively changed. Each secondary guide 170 is preferably selectively positionable with respect to its corresponding guide 162 by use of an adjustable affixment assembly 176. The affixment assembly 176 provides secure attachment of a secondary guide 170 to a distal portion of a corresponding guide 162, and most preferably allows the relative position of the secondary guide 170 to be changed. A threaded fastener extending through a slot in the secondary guide as shown can be utilized. The secondary guides 170 serve to provide further physical limits for deformation of the flexible member 30. FIG. 11 illustrates the flexible member 30 in a deformed state, and the side walls 34 of the member 30 contacting the inner ends 172 of the secondary guides 170 to limit further deformation outward by the sidewalls 34 of the flexible member 30.

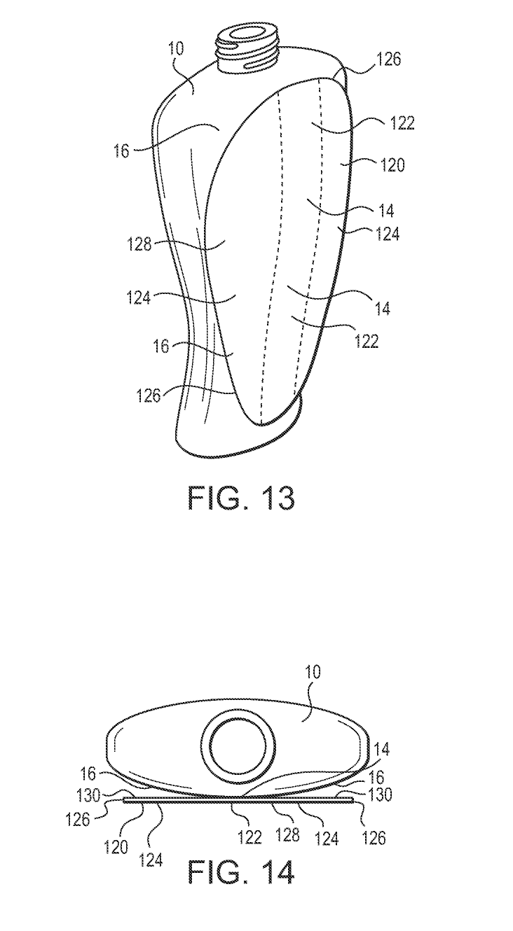

FIGS. 13 to 18 schematically illustrate application of a label to a container, and particularly, a container having one or more compound curved region(s) 16, using the flexible member 30 in accordance with the present invention. Referring to FIGS. 13 and 14, the container 10 previously described in conjunction with FIGS. 1 to 3 is provided. A label 120 defining a central region 122, an outer edge 126, and an outer peripheral region 124 extending between the central region 122 and the edge 126 is provided. It will be appreciated that the thickness of the label 120 has been exaggerated for ease in showing the label. The label 120 also defines an outer face 128 and an inner face 130. An effective amount of a pressure sensitive adhesive preferably extends across the inner face 130 of the label 120. The label 120 includes a heat shrink material and preferably, one exhibiting balanced shrink properties as described herein.

Preferably, the label 120 is initially contacted and retained along a region of the container 10. Preferably, the inner face 130 of the label within a central region 122 of the label, is contacted with a flat region 14 of the container 10. Other regions of the label 120 such as the outer peripheral regions 124 which overlie compound curved regions 16 of the container 10, are not contacted therewith. The inner face 130 of the label 120 preferably contains a pressure sensitive adhesive, thus upon the noted contact, the label 120 is maintained in contact with the container 10. It will be understood that the present invention includes a wide array of label application techniques, labels, containers, and label materials. As previously noted, the present invention can be used to apply films and labels onto other surface configurations besides those that include compound curves. For example, the present invention could be used to apply a label onto a container surface that was planar, included only a simple curve, or combinations of these geometries.

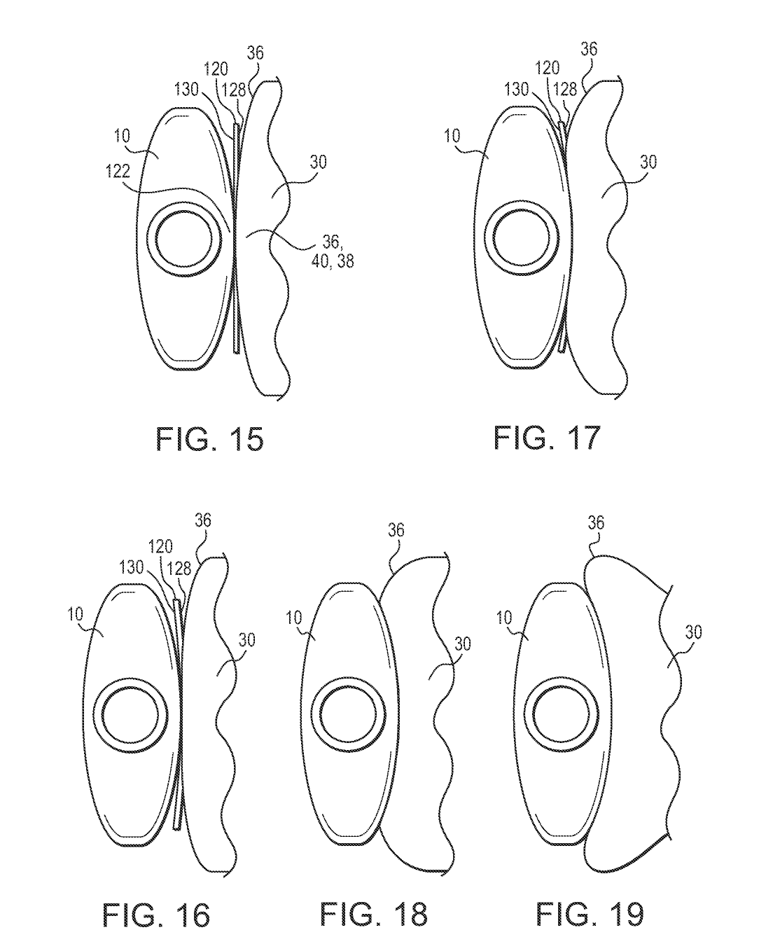

FIGS. 15 to 19 illustrate progressively contacting the label 120 to the container 10. After initial contact between the label 120 and the container 10; the flexible member 30, and particularly the domed region 36 of the flexible member, is brought into contact with the outer face 128 of the label 120. This is shown in FIG. 15. It will be appreciated that this contact may be accomplished by (i) moving the flexible member 30 toward a stationary container 10 and label 120, (ii) by moving the container 10 and label 120 toward a stationary flexible member 30, or (iii) by moving the container 10 and label 120, and the flexible member 30 into contact. The contact between the flexible member 30 and the label 120 preferably initially occurs within a central region 38 and most preferably occurs within or including a distalmost location 40 defined along the domed region 36 of the flexible member 30. Regarding the label 120, contact with the flexible member 30 preferably initially occurs within the central region 122 of the label 120.

The flexible member 30 is urged against the container 10 and label 120 as shown in FIGS. 16 to 19. Due to the flexible characteristic of the member 30, the member 30 begins to deform and continues to deform whereby it adopts the contour and/or shape of the container 120. The flexible member 30 is urged against the container 10 and label 120 (or the container and label are urged against the flexible member), by application of a load or other force. As previously noted, the amount of the load is such that the pressure applied to the label is preferably from about 690 N/m² to about 6900 N/m². Progressive contact between the flexible member 30 and the container 10 and label 120 can be seen in the sequence of FIGS. 15 to 19. After contact to the extent depicted in FIG. 19, the flexible member 30 and/or the container 10 to which the label 120 is fully adhered, are disengaged from one another. The result is that the label is fittingly applied onto the container.

Throughout the entire process depicted by the sequence of FIGS. 14 to 19, the flexible member 30 is preferably heated. As previously explained, the heating preferably occurs such that the outer regions 42 (see FIG. 4) of the domed region 36 of the flexible member are preferentially heated as compared to the central region 38 of the domed region 36. This practice promotes heating of only outer peripheral regions 124 of the label 120. Typically, the regions of a label that contact compound curved surfaces of a container, are the outer peripheral label regions 124. In accordance with the present invention, factors such as the amount of heat, rate of heating, rate of increasing contact between the flexible member and the container/label, and label application force are controlled such that the outer peripheral regions of a label are heated and shrunk to an appropriate extent such that upon contact with a compound curved container surface, the label is free from darts, wrinkles, or other defects. And, upon contact between label and container, the adhesive bond precludes subsequent movement of the portion of label in contact with the container.

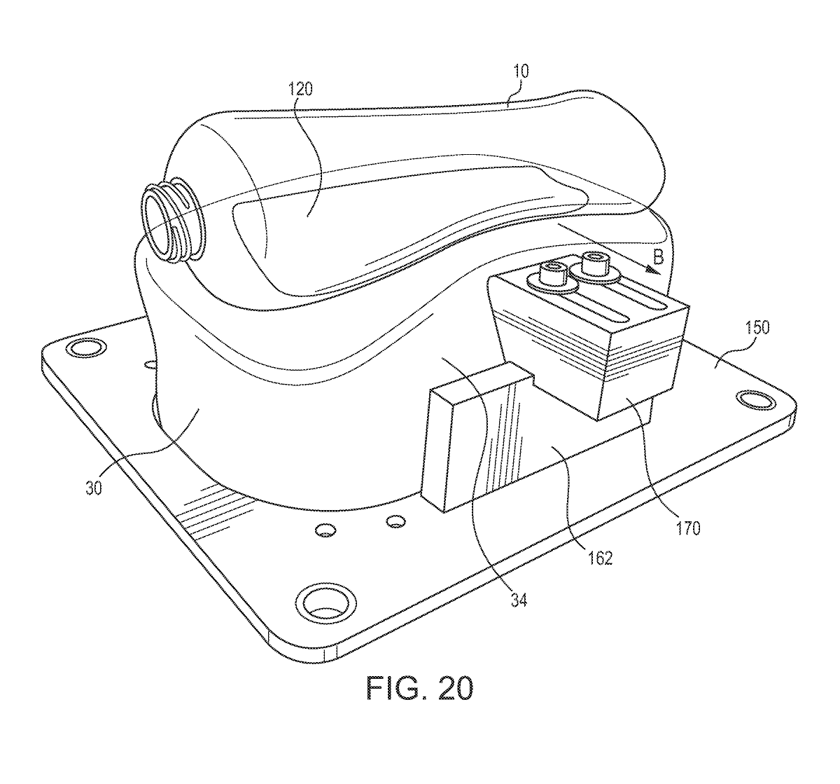

FIG. 20 is a perspective view illustrating contact between the flexible member 30 and the container 10, showing a typical extent of deformation of the flexible member 30. In this illustration, the container 10 is transparent thereby revealing the label 120 adhered thereto. The function of the guide 162 and the secondary guide 170 is clearly shown. Outward lateral deformation of the flexible member 30, such as in the direction of arrow B, is prevented due to the presence of the guide 162 and the secondary guide 170. Contact occurs between a region of the sidewall 34 of the flexible member 30 and the guides 162 and 170.

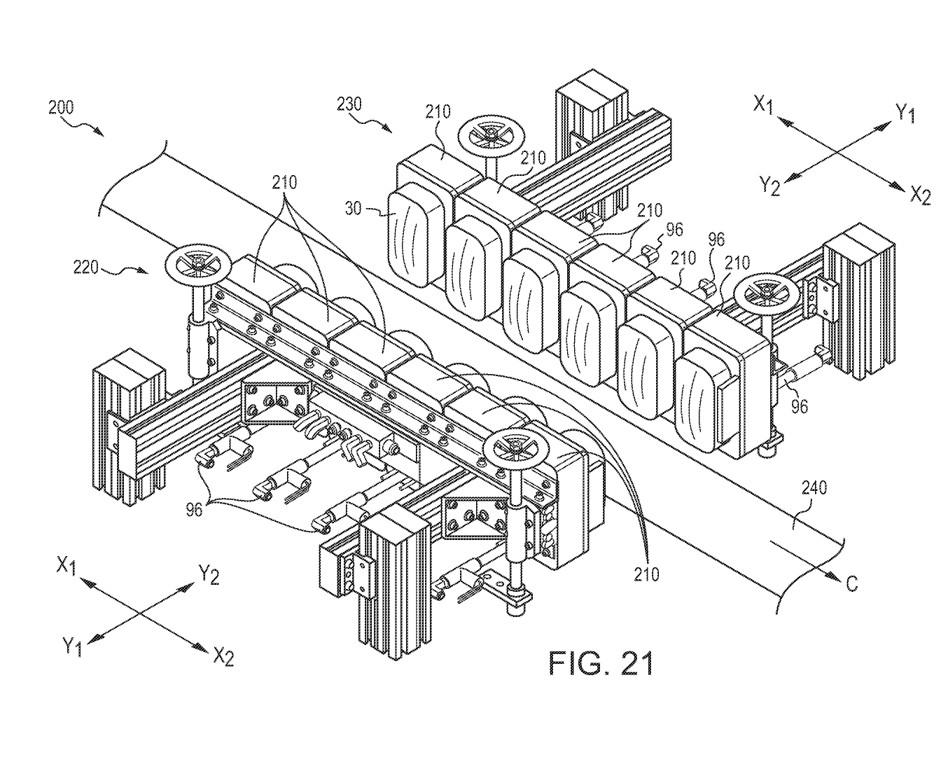

FIG. 21 illustrates an assembly 200 of a plurality of flexible members, each supported and housed within a corresponding frame and enclosure as previously described and collectively referred to as a label applicator 210. Specifically, the assembly 200 includes a first set 220 of label applicators 210 and a second set 230 of label applicators 210. The two sets 220 and 230 are preferably arranged across from one another aligned, and separated by a conveyor 240 or other product transport system. The assembly 200 is shown as configured for applying labels onto opposite sides of a container (not shown), and in particular, upon six (6) containers at a time. In accordance with this aspect of the present invention, a plurality of containers (not shown), evenly spaced from one another, are positioned on the moving conveyor 240. The conveyor 240 moves the containers in the direction of arrow C. Each set 220, 230 of the label applicators 210 is selectively positionable in the directions X and Y as shown in FIG. 21. The movement, i.e. direction and speed, of each set 220, 230 is coordinated to match a set of six adjacent containers moving on the conveyor 240. A representative cycle is as follows. Each of the sets 220, 230 is retracted by movement in the directions of X₁, and Y₁. As a set of targeted containers, six in number, each preferably carrying a partially contacted label as shown in FIG. 13, moves alongside the sets 220, 230, the sets are then moved in the direction of X₂. The speed of each set 220, 230 in the direction of X₂ is matched to that of the targeted containers moving on the conveyor 240. Concurrently with movement in the direction of X₂, each set 220, 230 is moved in the direction of Y₂ towards the targeted containers on the conveyor 240. Movement of each set 220, 230 continues as contact occurs between each flexible member 30 and a corresponding label. Each label is applied to its corresponding container as previously described in conjunction with FIGS. 14 to 19. As the labels are being applied, the collection of the sets 220, 230 and the six targeted containers are moving in the direction of arrows C and X₂. After label application, each set 220, 230 is retracted by moving it in the direction of arrow Y₁. When the sets 220, 230 are retracted in the Y₁ direction, the beam is still moving in the X₂ direction. It is not until after the heads are fully retracted in the Y₁ direction that the beam begins to move in the X₁ direction in preparation for the next set of targeted containers.

Movement of the sets 220, 230 can be performed by a variety of different techniques and assemblies. In one approach, each of the sets is positioned on a movable slide assembly that can be selectively positioned on a linear track by one or more electrically powered servo motors. It is also contemplated that one or more cam assemblies could be used to impart the desired motion to each of the sets 220, 230.

Although the foregoing description is provided in the application of labels to six (6) containers at a time, it will be appreciated that the present invention can be tailored to concurrently apply labels to nearly any number of containers, designated herein as “n.” Preferably, n typically ranges from about 1 to about 20, and more preferably from about 4 to about 10. It will be appreciated that in no way is the present invention limited to these configurations. Instead, the invention can be utilized to simultaneously apply, or nearly so, labels to sets of containers numbering more than 20. Moreover, although the assembly depicted in FIG. 21 is for applying labels to two oppositely directed faces of a container, the invention includes configurations in which only a single label is applied per container, or three or more labels are concurrently applied per container.

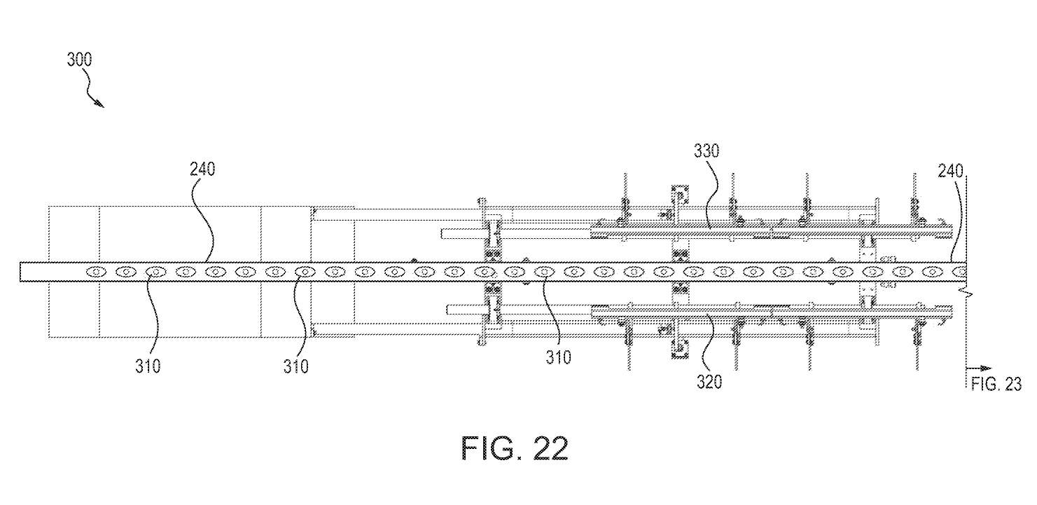

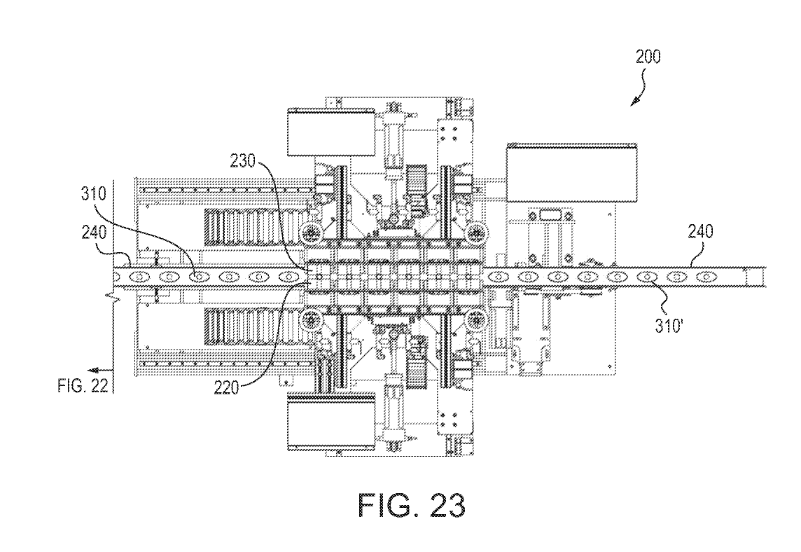

FIG. 22 is a top planar view of a preheating stage 300 that can be used in combination with the assembly 200 depicted in FIG. 20. Referring to FIG. 22, the conveyor 240 is shown transporting a plurality of containers 310. Each container 310 carries a label on each of its two major faces. Each label is partially contacted and adhered to a corresponding container face in the manner as shown in FIG. 14. The collection of containers 310 are transported alongside a collection of heaters such as a first heater 320 for heating labels on a first side of the containers 310 and a second heater 330 for heating labels on a second side of the containers 310. As previously noted, a wide variety of heater types, heat outputs, and configurations can be used. However, it is preferred that the heaters 320 and 330 be in the form of infrared heaters. Labels exiting this preheating stage typically exhibit temperatures of about 38° C. However, it is to be appreciated that the particular temperature to which the labels are heated, depends upon numerous factors including for example the heat shrink activation temperature of the labels.

Referring to FIG. 23, containers 310 and labels exiting the preheating stage 300 from FIG. 22 enter the assembly 200 as previously described in conjunction with FIG. 21. Containers having fully applied labels are designated as containers 310′. It will be appreciated that during transport through the assembly 200, the containers and their corresponding labels are subjected to the operations depicted in FIGS. 15-19.

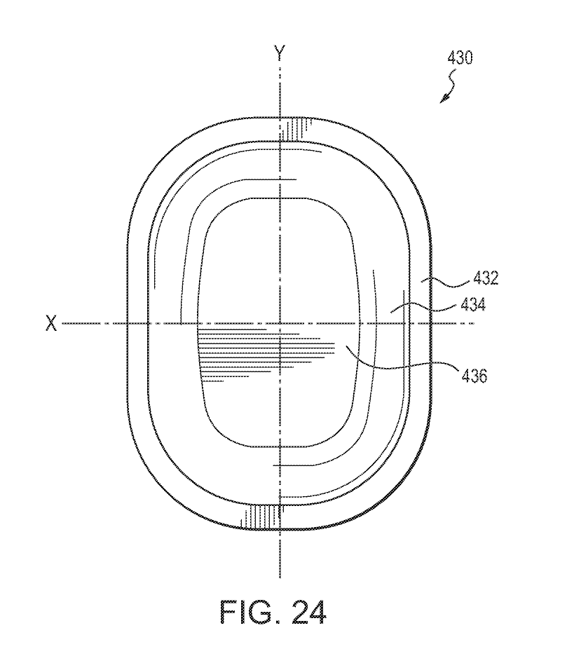

FIG. 24 schematically illustrates a front view of a preferred embodiment flexible member 430 comprising a base 432, a domed region 436, and one or more side walls 434. As shown, the flexible member 430 generally has a rectangular shape with rounded corners or edges when viewed along its front face. The base 432 generally extends around the outer periphery of the member 430. The member 430 is generally symmetrical about its longitudinal (and vertical) axis designated as axis Y. The member 430 is also generally symmetrical about its width (and horizontal) axis designated as X.

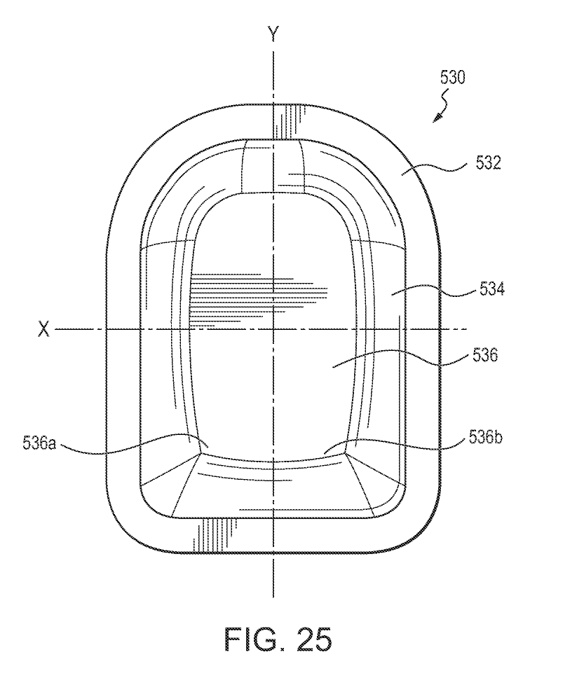

FIG. 25 schematically illustrates a front view of another preferred embodiment flexible member 530 comprising a base 532, a domed region 536, and one or more side walls 534 extending therebetween. The domed region 536 includes outwardly extending lower corner regions 536a and 536b. In this embodiment, the flexible member 530 features a symmetrical shape about only one axis, its longitudinal axis Y. The shape of the flexible member 530 is different and non-symmetrical about axis X. As previously noted, the shape and/or contour of a flexible member depends at least upon the shape of the label and/or the shape or contour of the container. The flexible member 530 depicted in FIG. 25 more fully contacts lower edge and lower corner regions of a label than the flexible member 430 of FIG. 24, due to the outwardly extending lower corner regions 536a and 536b. Again, it will be understood that the present invention includes a wide array of shapes and configurations for the flexible member. The particular shape and configuration of a flexible member is primarily dictated by the characteristics of labels and containers. Thus, it will be appreciated that in no way is the invention limited to the particular flexible members described herein such as members 430 and 530.

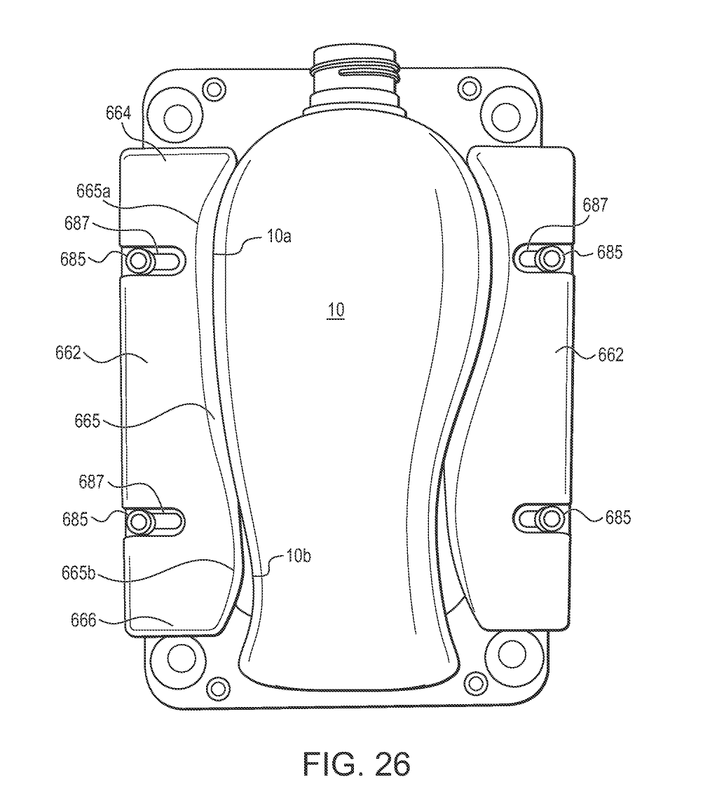

FIG. 26 illustrates a pair of guides 662 adjustably and selectively engaged or positionable with a frame or other support member by use of threaded members 685 extending through apertures 687 defined in each guide 662. Each guide includes an upper region 664, a lower region 666, and an inner side 665 extending therebetween. As shown in FIG. 26, a container 10 is positioned between the pair of spaced apart guides 662. The container 10 has curved sides or side regions as shown in FIG. 26. The guides 662 are each preferably shaped or contoured to match, follow, or generally correspond to the lateral side regions of the container 10. Thus, the inner side 665 of each guide 662 preferably extends alongside the container 10 and is relatively closely spaced therefrom.

More specifically, as depicted in FIG. 26, container 10 defines an outwardly projecting or convex lateral region 10a and the guide inner side 665 defines a corresponding inwardly recessed concave guide inner side region 665a. In addition, container 10 further defines an inwardly recessed concave lateral region 10b and the guide inner side 665 defines a corresponding outwardly projecting or convex guide inner side region 665b. For many applications, it is particularly preferred that the configuration of an inner side closely correspond to and generally follow the contour of the container of interest. Thus, spacing between the inner side of a guide and a container, when positioned into appropriate relationship therewith, is relatively uniform and constant from a guide upper region to a guide lower region. This is in contrast to the particular arrangement depicted in FIG. 26, in which a relatively large spacing is provided between container and guide inner sides, proximate the guide lower regions, and a relatively narrow spacing adjacent the guide upper regions.

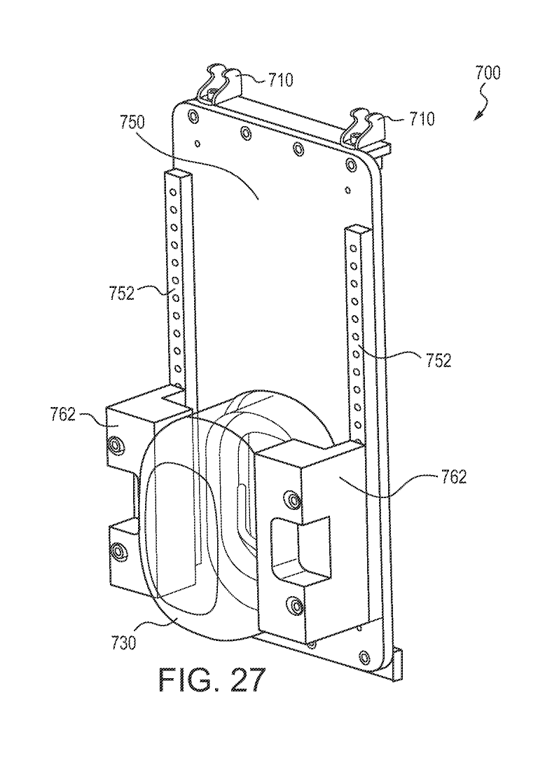

FIG. 27 further illustrates a perspective view of a preferred embodiment “quick change” system 700. The quick change system includes a flexible member 730, guides 762, and a frame assembly 750. The guides 762 are adjustably and selectively positionable with respect to the frame 750 and preferably vertically positionable by use of one or more rail members 752. The system 700 includes a wide array of provisions for releasably engaging the system 700 to a larger frame or support, or as previously noted, to a walking beam apparatus (not shown). An example of such releasable engagement provisions include clamping members such as depicted as 710. Other fastening means can be used such as threaded fasteners.

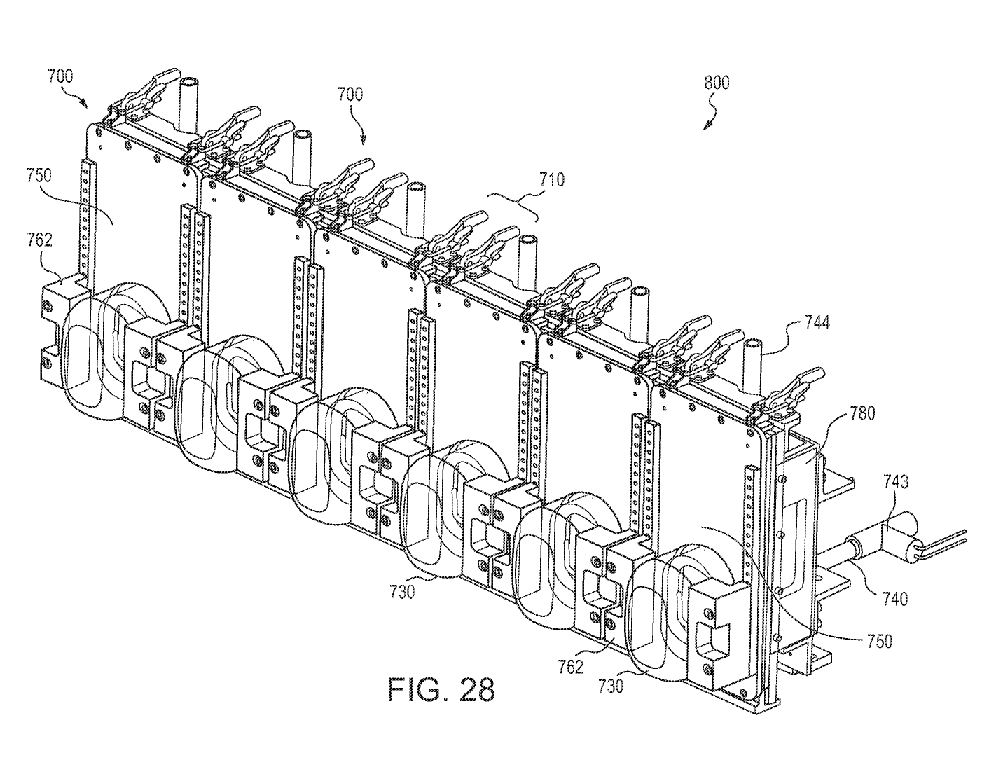

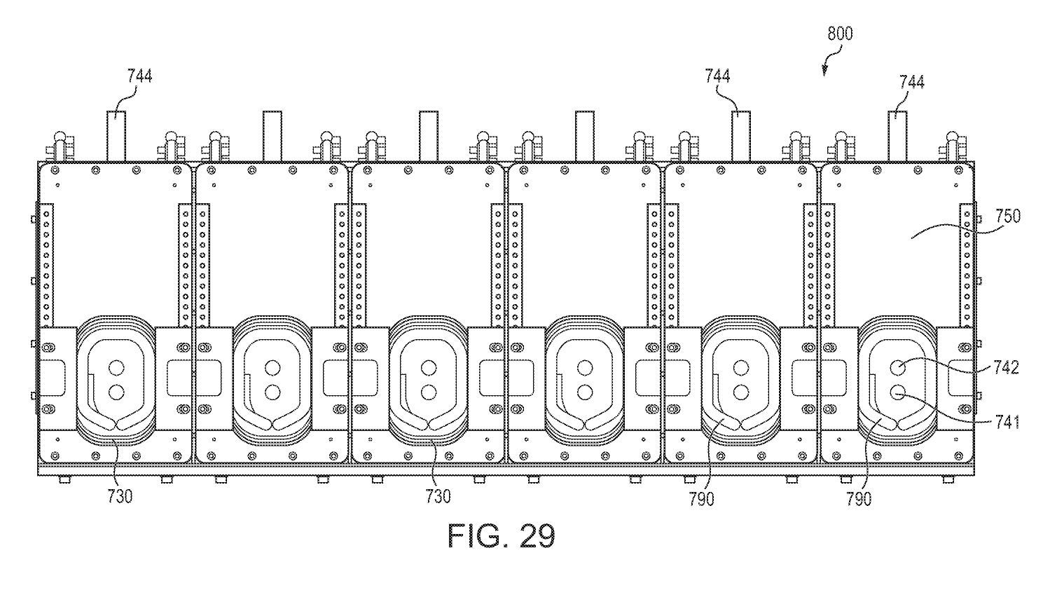

FIGS. 28 and 29 illustrate a plurality of quick change systems 700 collectively referred to as a labeling group 800. FIG. 28 is a perspective view and FIG. 29 is a front elevational view of the labeling group 800. Each system 700 is as previously described with respect to FIG. 27. Each system 700 is selectively engageable with a frame portion 780. Each frame portion 780 includes provisions for directing heated air into a flexible member 730 such as air inlet 740 having an inline electrically operated heater 743, and an air exit 744. Referring further to FIGS. 28 and 29, defined in frame 750, are an air inlet opening 741 and an air outlet opening 742. As previously described in association with heater 110 in FIG. 10, the heater 743 may include an interior flow region or conduit section. Thus, heated air flowing past heater 743 through inlet 740 enters the interior of a flexible member 730 via opening 741. Heated air circulates within the flexible member 730, preferably further distributed by an air manifold or diffuser (not shown), and exits via opening 742 and through air exit 744. Positioned within each flexible member 730 is a heater 790. Clamping members 710 or other securing assemblies can be used to selectively and releasably disengage a flexible member 730, its guides 762, and its frame 750 from the other frame 780.

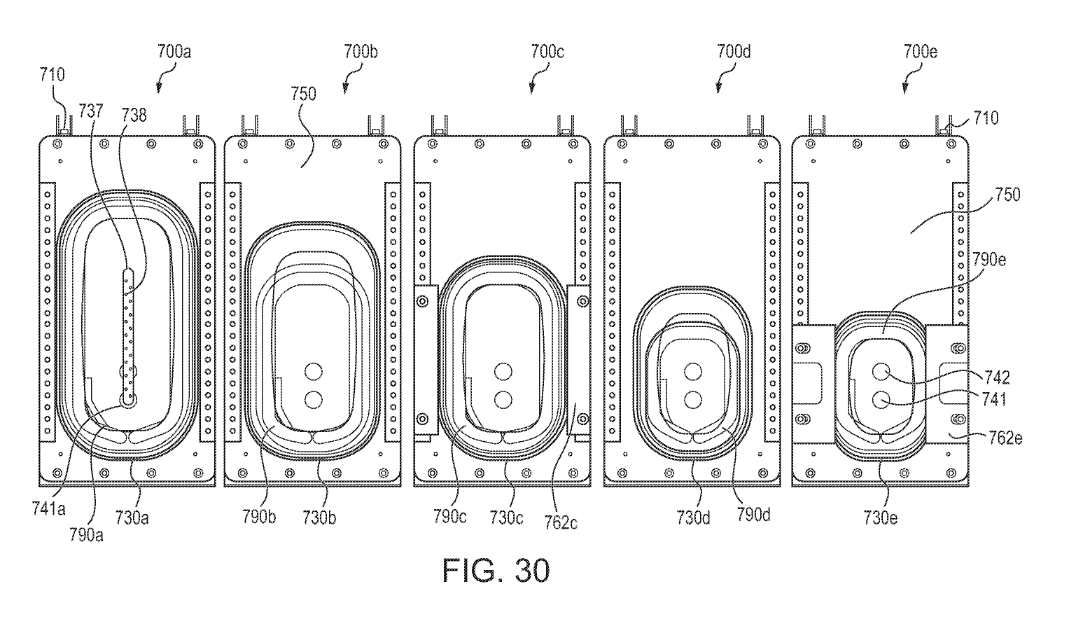

FIG. 30 illustrates five different quick change systems designated as 700a, 700b, 700c, 700d, and 700e, each using a different size flexible member, shown as 730a, 730b, 730c, 730d, and 730e. Each system may include one or more guides such as 762c and 762e, or be free of such guides. In addition, each system may include different sizes, shapes, and configurations of heaters 790a, 790b, 790c, 790d, and 790e, disposed within the flexible members. Clamping or other releasable engagement provisions 710 are provided for each system 700a-700e. FIG. 30 also depicts a preferred arrangement of the air openings 741 and 742 relative to flexible members 730a-730e. Regardless of the size of the flexible member 730a-730e, upon engaging the frame 750 to the frame 780 (see FIG. 28), the air openings 741 and 742 are aligned with air inlet 740 and air exit 744. This configuration further facilitates fast and easy removal and installation of one system 700 for another, such as replacing system 700e with system 700a or vice versa. As will be appreciated, this enables convenient changeout of one flexible member for another. Thus, a flexible member having a particular configuration designed for one label and/or container type can be easily changed when another container and/or label are used. FIG. 30 also illustrates a representative air manifold 737 having a hollow interior and defining a plurality of apertures 738 extending through the side wall of the manifold. It will be understood that the air manifold 737 may utilize nearly any pattern or arrangement of apertures 738, and in no way is limited to the particular embodiment depicted in FIG. 30.

The invention also provides various label processing systems for contacting a label to a container. These systems comprise a label processor for concurrently heating and contacting a label to a container. The label processors are preferably as described herein. The label processing systems also comprise one or more labels for heating and contacting to a container by the processor.

### Application of Label Using Wiping Members

In general, the present invention provides various techniques and assemblies for selectively applying one or more regions of a label or label assembly to a container. Specifically, the techniques and assemblies are utilized to control the regions of a label that are contacted with a container. By selectively controlling the geometry and size or proportions of label “flags” during a labeling operation, greater overall control of a labeling process can be achieved. The techniques and assemblies as described herein have particular significance in labeling operations using heat shrink labels and pressure sensitive adhesives.

In certain labeling operations such as for applying labels onto complex curved surfaces, a multi-step strategy is utilized. In particular, this multi-step strategy is useful for applying heat shrink labels using pressure sensitive adhesives. The label or label assembly is initially applied to a container or other receiving surface by contacting only a portion of label to a desired region of the container. Exposed adhesive such as pressure sensitive adhesive along a rear face of the label contacts the container and retains the label relative to the container, which is typically moving on a conveyor. The resulting regions of the label that are not in contact with the container are sometimes referred to in the industry as “flags” or “wings.”

The label is then fully contacted with and adhered to the container in a variety of different techniques, largely depending upon the geometry of the container and characteristics of the label and adhesive. For heat shrink labels using pressure sensitive adhesives, the remaining uncontacted label portions or “flags” are preferably contacted with the container using a deformable heated member. The motion and temperature of the heated member are carefully controlled to heat the label or portion(s) thereof, to desired temperatures in order to achieve a desired degree of shrinkage in the label portion(s). The heating is carefully controlled relative to occurrence of contact between the label and container with a goal of reducing or ideally avoiding, the occurrence of wrinkles, darts, edge lifting, or other defects in the applied label.

The present invention provides systems and methods for partially or fully applying a label to a moving container in a defect-free manner. The label is initially contacted with and carried by the moving container. In one version of the invention, the label is further applied to the container however not fully applied, so that one or more label flags remain. The label can be fully applied to the container and label flags applied to corresponding regions of the container by one or more subsequent operations such as use of a heated flexible wiping member. In another version of the invention, the label is completely applied to the container. In this version, the flags resulting after initial contact between the label and the container are fully contacted with the container.

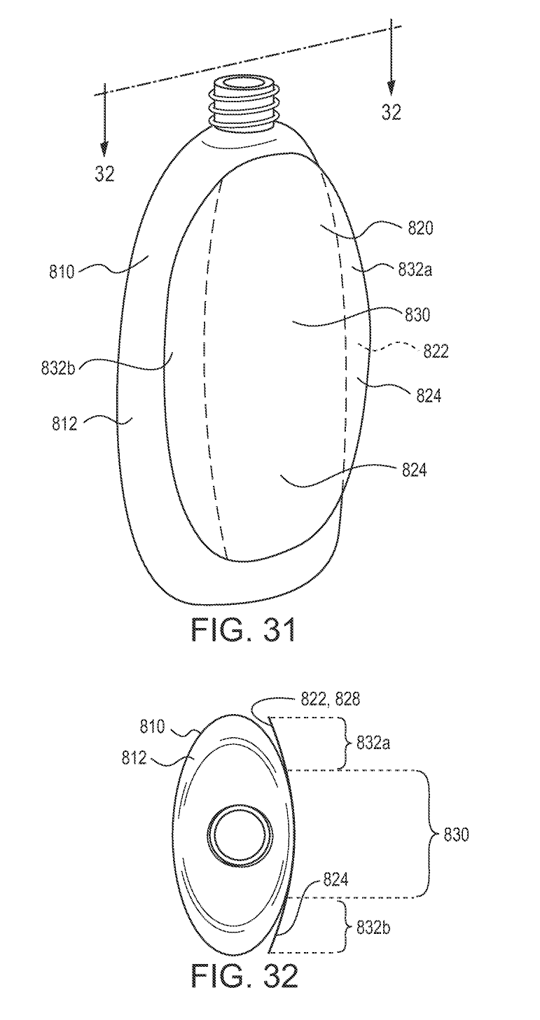

FIG. 31 illustrates a typical container 810 having a container exterior surface 812 to which a label 820 is applied in accordance with the present invention. Specifically, a label is initially only partially contacted to a container or receiving surface such that one or more desired label portions remain uncontacted with the container. FIG. 31 illustrates such a state in which the label 820 is partially contacted with and partially adhered to the container 810.

The region of initial contact between the label 820 and the container 810 is depicted in FIGS. 31 and 32 as region 830. The remaining label regions that are not in contact with the container are flags 832a and 832b. As previously noted, the term “flag” as used herein refers to an uncontacted portion of a label, typically including one or more edge regions. Although two separate flag portions 832a and 832b are illustrated in FIGS. 31 and 32, it will be appreciated that three or more flags, or a single flag, may be associated with a label and its initial application to a container. The front face of the label 820 is generally designated as a front face 824. And, the rear face of the label 820 is designated as rear face 822. An effective amount of adhesive 828 such as a pressure sensitive adhesive, is typically disposed along the rear face 822 of the label 820.

Specifically, the present invention is directed to a multi-step labeling operation in which a pressure sensitive label is initially partially contacted to a desired location along an outer face of a container. The label is concurrently and incrementally subjected to a wiping operation whereby additional regions of the label are contacted with and applied to the container. Preferably, the wiping operation is terminated prior to the entire label being contacted with the container. Most preferably, wiping is performed only until at least one or more flags exist. At this juncture, the wiping operation is completed and the container now carrying the partially applied label is directed to another process operation such as contact from a flexible heated member. However, as previously noted, the present invention includes a labeling operation in which a label and preferably a pressure sensitive label, is fully contacted with and applied to a container so that the applied label is free of flags.

Although not wishing to be bound to any particular theory, this multi-step labeling operation has been discovered to be particularly well suited for applying heat shrink pressure sensitive labels onto curved container surfaces and especially container surfaces exhibiting compound curved surfaces. Typically, such containers exhibit a somewhat planar or slightly arcuate and convex front or rear region that along its lateral regions, dramatically curves inward to form complex curved shoulders or sides that meet a corresponding surface from the other side of the container. Attempting to apply a label and in particular, a heat shrink pressure sensitive label, in a defect-free manner over the sharply curved and typically complex curved regions is very difficult. Surprisingly, by use of the present invention, a label can be readily applied by initially contacting a select region of the label to a portion of the container and then contacting and applying additional amounts of the label to the container by selectively wiping the label. Preferably, wiping is performed to an extent such that at least one or more label regions remain which are not contacting the container. The label portions not in contact with the container are label flags. Preferably, the flags that are formed correspond to and thus overlie regions of the container that exhibit compound curvature. The flags are subsequently applied to the compoundly curved container surfaces by one or more subsequent operations such as the noted flexible heated member for example. In certain applications, it may be possible to fully apply the label so that no label flags remain. For these applications, it would likely not be necessary to subject the labeled container to a flexible heated member.

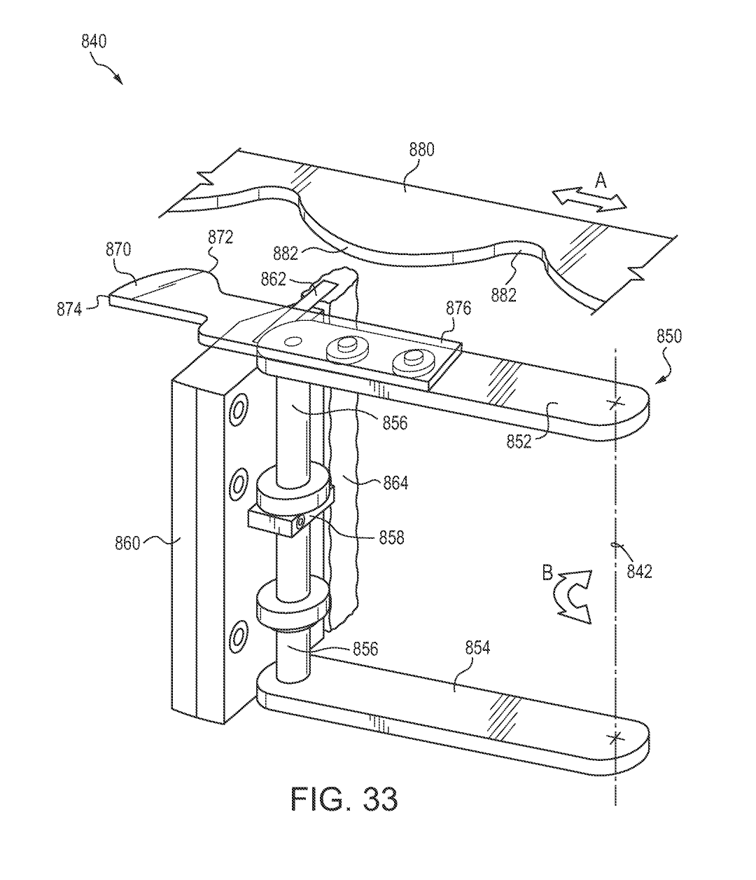

FIG. 33 is a perspective view of a preferred embodiment wiping assembly 840 in accordance with the present invention. The various wiping assemblies described herein are used to selectively apply a label and controllably wipe, i.e. incrementally contact, one or more regions of the label including (i) all or a portion of a contacted label region such as region 830 in FIGS. 31 and 32, and (ii) all or a portion of a flag region such as one or both of regions 832a and 832b in FIGS. 31 and 32. The preferred embodiment wiping assembly 840 is utilized to initially apply a label from a label dispenser (not shown in FIG. 33) and further utilized thereafter to incrementally apply and “wipe” the label to the container. The wiping assembly 840 comprises a frame 850, a wiper member 860, a cam 880, and a cam follower member 870. Each of these components is described in greater detail herein.

The frame 850 generally includes one or more members for supporting and positioning the wiper member 860. Preferably, the frame 850 includes an upper frame member 852, a lower frame member 854, and one or more support members extending therebetween such as a vertical support member 856. The materials used for the frame can be nearly any material exhibiting suitable strength and rigidity. Non-limiting examples for frame materials include metals such as steel and aluminum, and relatively rigid plastics. One or more mounts 858 or other affixment components can be used to affix or otherwise attach the wiper member 860 to the frame 850. The frame 850 is pivotally mounted to a support or other fixture (not shown) such that the frame 850 can be pivoted about a pivot axis 842 as shown in FIG. 33. Preferably, the frame 850 and the wiper member 860 affixed thereto, can be pivoted about the axis 842 in the direction of arrow B. The manner by which pivotal movement of the frame is achieved is explained in greater detail herein.

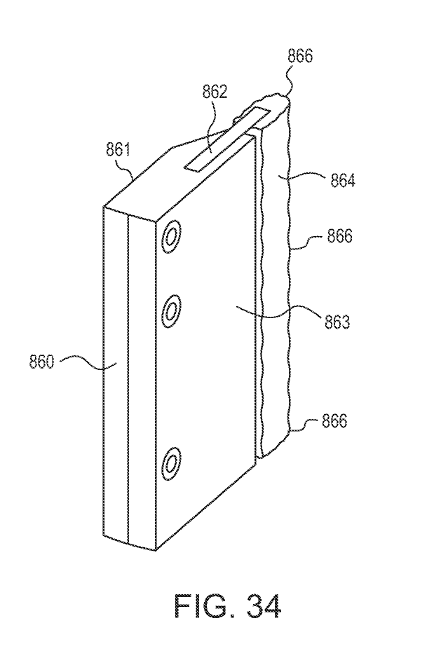

The wiper member 860 is illustrated in isolation in FIG. 34. Although the present invention includes a variety of forms and configurations for the wiper member 860, the member 860 preferably has a relatively planar shape defining a front face 861 and an oppositely directed rear face 863. The wiper member 860 also includes one or more blades 862 that preferably extend from an edge or side region laterally outward. The blade 862 is preferably flexible and deformable and so the materials selected for the blade are accordingly selected. Representative examples for materials for the blade 862 include, but are not limited to silicones, rubbers, flexible plastics, and various composite materials. The wiper member 860 also includes a wiping element 864 preferably disposed along a distal edge or region of the blade 862. During use of the wiping assembly 840, the wiping element 864 contacts a label along one or more contacting regions 866 of the wiping element 864. The material(s) selected for use as the wiping element 864 depend upon the label characteristics and the smoothness of the wiping element 864 and tendency for the element to move across the label. Non-limiting examples of materials that may be suitable as the wiping element 864 include, but are not limited to woven and nonwoven fibers of cotton, polymeric materials, molded elastomeric materials and the like. Depending upon the materials of the label and characteristics of any printing or overcoat layers, it may also be desirable to use one or more lubricating or friction-reducing agents along the wiping element. Again, it is to be understood that the invention includes a wide array of shapes, configurations, and materials for the wiper member 860. For the particular preferred wiping assembly 840 described herein, it is preferred that the wiping element 864 continuously extends over the entire length or substantially so, of the blade 862. And, it is preferred that the blade 862 continuously extends over the entire length or substantially so, of the wiper member 860.

The preferred embodiment wiping assembly 840 also includes a cam follower member 870. The cam follower member 870 is engaged to, and preferably affixed to, the frame 850 such that movement of the member 870 is imparted to the frame 850. As depicted in FIG. 33, the cam follower member 870 can be affixed to an upper frame member 852 of the frame 850 by one or more bolts or other fasteners. Other affixment means can be used such as welding, adhesives, or integrally forming the cam follower member 870 with one or more members of the frame 850. The preferred configuration depicted in FIG. 33 is described in greater detail herein. The cam follower member 870 may be in a wide variety of shapes and configurations. Preferably, the member 870 defines a proximal end 876 at which the member 870 is attached to the frame 850, and an opposite distal end 874. The distal end 874 preferably defines a cam follower surface 872 that is directed toward the cam member 880. In a preferred configuration of the member 870, the cam follower surface 872 is provided along a laterally directed side or edge region of the member 870 and particularly along the distal end 874 or portion thereof. The cam follower member 870 can be formed from nearly any material such as metals including steel and aluminum for example, or plastics such as Lexan, polyethylene, or other low surface energy materials.

The wiping assembly 840 in certain embodiments may also include a cam member 880. The cam member 880 is positioned to be in operable engagement with the cam follower member 870 such that movement of the member 880 induces a predefined cyclical and preferably reciprocal movement of the follower member 870. In the representative configuration depicted in FIG. 33, the cam member 880 moves in a linear fashion in the direction of arrow A which due to the operable engagement with the cam follower member 870, induces reciprocating pivotal movement of the frame 850 and the wiper member 860 in the direction of arrow B, and specifically, about the pivot axis 842. Preferably, the cam member 880 defines a cam surface 882 directed toward the cam follower member 870, and particularly toward the cam follower surface 872. As will be understood, upon and during engagement between the cam member 880 and the cam follower member 870, a portion of the cam follower surface 872 is in contact with a portion of the cam surface 882. Although the invention includes a wide array of configurations and arrangements, preferably, the cam member 880 and the cam follower member 870 are arranged such that linear displacement of the cam member 880 results in reciprocating pivotal movement of the cam follower member 870.

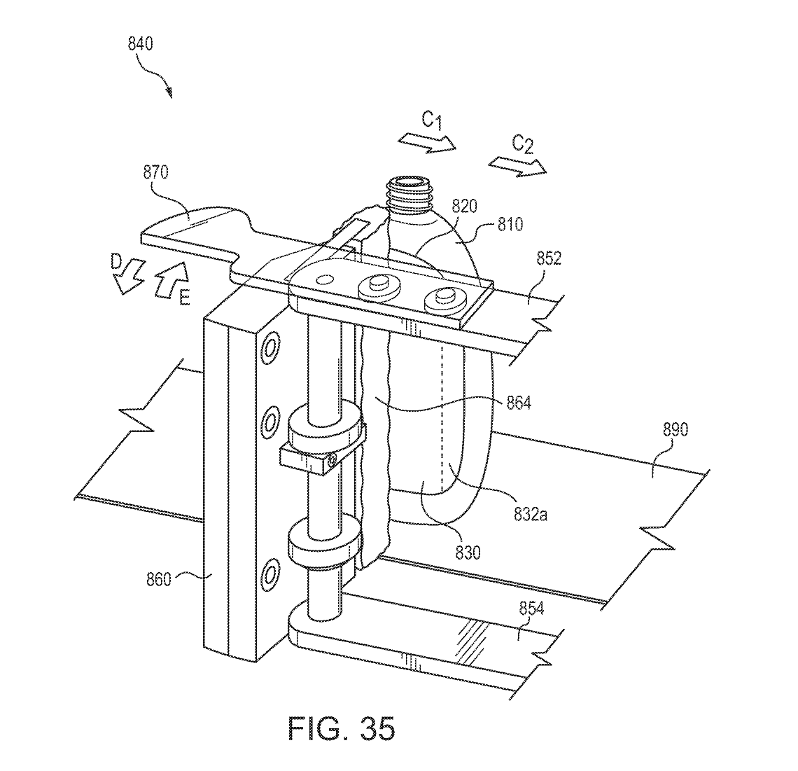

FIG. 35 illustrates typical positioning and orientation of a container 810 carrying a partially contacting label 820. The label is initially contacted to the container upstream and preferably immediately upstream of the wiping assembly 840. In a particularly preferred process described in greater detail herein, the label 820 is initially contacted to the container 810 by the wiping assembly 840. Once contacted therewith, the container continues to carry the partially applied label toward the wiping assembly 840 at which the label is further contacted with and applied to the container. Typically, the container 810 is disposed on a conveyor 890 that moves past the wiping assembly 840. A wide array of conveyors can be used in association with the various wiping assemblies of the present invention. Generally, the conveyor transports containers that are preferably arranged on the conveyor such that the containers are equally spaced from one another and uniformly aligned with respect to one another. The containers are preferably arranged in a single file line on the conveyor, although it will be appreciated that the invention includes other container arrangements. As for the configuration of the conveyor, it is generally preferred to utilize a linear conveyor and in particular, one having a conveyor section that is linear and which transports containers in a straight line direction past the wiping assembly and in particular, the wiping member. It is also preferred that the conveyor transports the containers in a continuous fashion such that the containers are continuously in motion and most preferably, so that the containers are in continuous motion as they move past the wiping member. The movement of the conveyor 890 is preferably synchronized to that of the cam member 880 (not shown) such that as the container 810 moves toward the wiping assembly 840, the cam follower 870 is first moved away from the container 810 and then moved towards the container 810. Specifically, it is preferred that as the conveyor 890 and container 810 disposed thereon are moved a first incremental amount C₁, the cam follower member 870, the frame 850, and the wiper member 860 pivotally move about axis 842 (shown in FIG. 33) in the direction of arrow D away from the container 810. Upon sufficient linear movement of the conveyor such as completion of the first incremental amount C₁, the conveyor 890 continues and undergoes further linear movement such as a second incremental amount C₂. As the conveyor 890 and container 810 disposed thereon moves through the second incremental amount C₂, the cam follower member 870, the frame 850, and the wiper member 860 pivotally move about axis 842 (shown in FIG. 33) in the direction of arrow E toward the container 810. Depending upon the relative positions of the cam member 880 and the cam follower member 870, and the profile or shape of the cam surface 882 and the cam follower surface 872, a wide array of movements of the wiper member 860 relative to a container 810 and its label 820, can be achieved. As the container 810 and label 820 move past the wiper member 860, the portion of the label 820 not in contact with the container 810 and which is upstream of the member 860 at that moment, is then pulled past the member 860, and specifically past the wiping element 864. Depending upon the shape and configuration of the wiping element 864, all or only select regions of the label can be urged toward the container 810 and contacted therewith. Thus, depending upon the previously noted aspects, the size, shape, and orientation of one or more flags can selectively be controlled. This is particularly desirable prior to subjecting a container and partially attached label to a heated flexible member for heat shrinking and final label adherence to the container.

In another preferred embodiment according to the present invention, the wiping assembly 840 does not include, and is free of, the cam member 880. Instead, the cam follower member 870 is positioned to periodically contact the containers moving past the wiping assembly. Most preferably, the cam follower 870 is positioned to periodically contact an upper region of each container such as an outer portion of a container neck or upwardly extending threaded region which receives a cap or other container closure member. Configuring and positioning the cam follower member 870 so that the member is actuated by the containers themselves promotes simplicity, consistency, and accuracy in operation of the associated process. This preferred embodiment is possible because in most if not all high speed, commercial container labeling operations, containers are held in place along a moving conveyor by an upper conveyor member. The contacting surface of the upper conveyor member is typically frictionally enhanced to promote engagement between that member and the container. The plurality of containers disposed between an upper and a lower conveyor are sufficiently held in position such that they can support, i.e. do not move, the cam follower member 870 contacting each container as the collection of containers move alongside and past the wiping assembly.

It will be appreciated that the present invention provides assemblies enabling the selective tailoring of the shape, size, and orientation of nearly any flag or other uncontacted label region. Thus, the invention can accommodate nearly any configuration of partially applied label upon a container, and be used to form or modify one or more flags associated with the label, prior to final label application and/or label heat shrinking. Or, the invention can be used to completely apply a partially applied label to a container so that no flags remain.

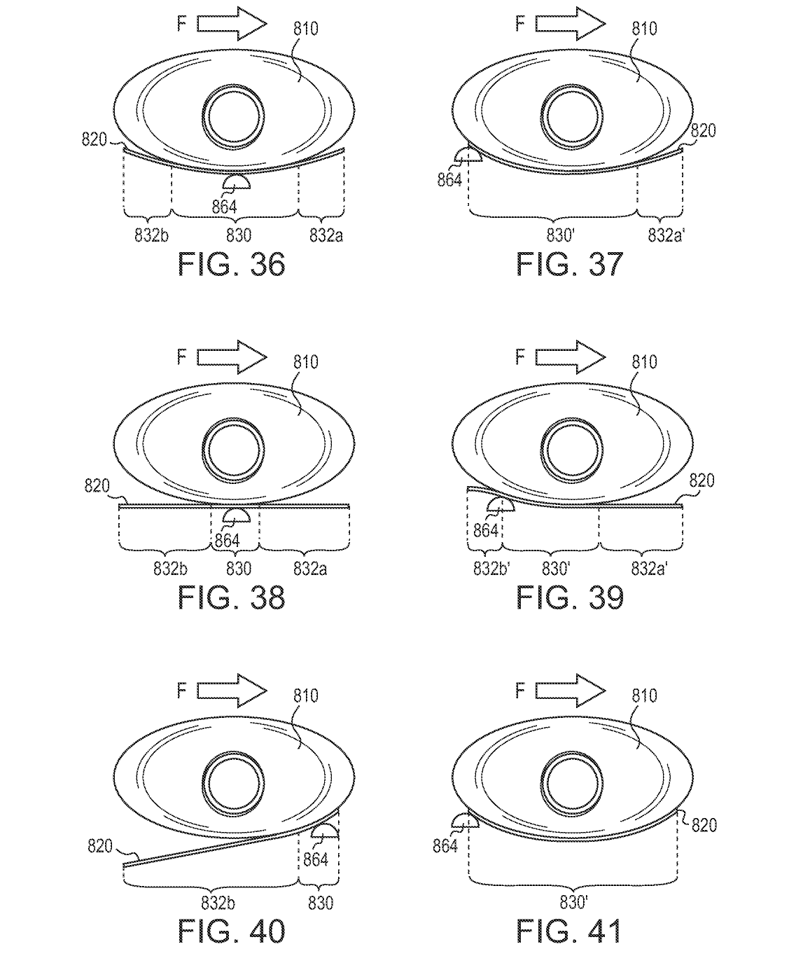

For example, FIG. 36 depicts a container 810 having a label 820 partially contacted thereto. The region of the label 820 in contact with the container 810 is shown as region 830 and the label regions not contacting the container 810 are shown as regions or flags 832a and 832b. The container 810 is moving past a wiping element 864 in the direction of arrow F. Thus, the flag 832a is downstream of the wiping element 864 and the flag 832b is upstream of that element. In this example, the wiping element 864 of a wiper member 860 (not shown) is brought into contact with the moving container 810 at a central location of region 830. As the container 810 and label 820 are moved past the wiping element 864, the element incrementally contacts or “wipes” the label 820 from its initial central location to a subsequent location proximate an outer edge region of the label 820 as depicted in FIG. 37. As will be noted in FIG. 37, after wiping of the label 820, the initial flag 832b has been entirely eliminated by contacting that label region to the container 810. As a result, the proportion or surface area of the region 830 has increased. Since no wiping or contact occurred regarding the downstream flag 832a, that flag remains unchanged. It will be appreciated that primes are used in association with regions 830 and 832a to designate those regions after the wiping operation by wiping element 864.

FIGS. 38 and 39 illustrate an initial container 810 and label 820 partially contacted therewith such that the contacting region 830 is relatively small in comparison to the flag regions 832a and 832b. In this example, it is desired to simply reduce the size or proportion of the upstream flag 832b and not to entirely eliminate that flag as in the example of FIGS. 36 and 37. A heated flexible member (not shown) could then be used to apply the label flag 832b to the container.

FIGS. 40 and 41 illustrate another example in which a label 820 is initially contacted with a container 810 along a leading edge of the label 820. A relatively large upstream flag 832b remains. The preferred embodiment assembly can be used to increase the contact region between the container 810 and the label 820, i.e. region 830, and thereby reduce or entirely eliminate the upstream flag 832b as shown in FIG. 41.

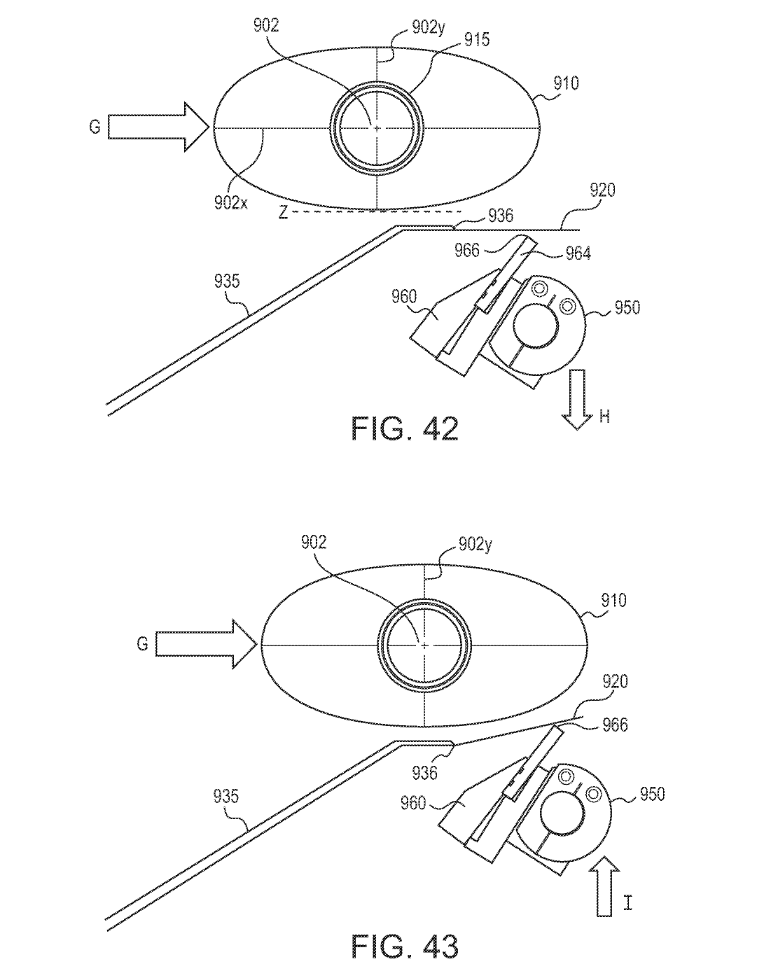

In a particularly preferred process according to the invention, the wiping assembly is used in conjunction with a label dispenser. FIGS. 42-44 and 46-49 illustrate various stages during a preferred embodiment labeling process in accordance with the invention. FIG. 45 illustrates a potential problem that can arise during a labeling operation. In these figures, a series of detailed schematic representations are provided depicting a preferred technique of applying a label and wiping the label using the preferred assemblies described. Generally, the various components of the wiping assembly, container, and label are as previously described and are denoted by similar reference numerals in the 900 series. Thus, for example, a frame 950 is referenced in FIGS. 42-49. The frame 950 corresponds to frame 850 previously described herein. Each of FIGS. 42-49 illustrate a container 910 during a labeling operation in which a label 920 is applied to the outer surface of the container by a wiper member 960 carried on a frame 950. In these figures, a label dispenser is schematically depicted as 935 having a label dispenser chute 936 from which the label 920 is administered. Nearly any type of label dispenser can be used in the assemblies, systems, and methods described herein. Generally, the label dispenser is configured or otherwise adapted to selectively position a label alongside a desired outer face of a container.

Referring to FIG. 42, the wiper member 960 and frame 950 are pivoted out of the way so the label can feed or dispense between the wiper and the container. This is accomplished by the cam follower, e.g. follower 870 illustrated in FIG. 35, contacting and pushing off from the neck of the container. Specifically, as the container 910 is moved toward the wiping member 960 and the frame 950 in the direction of arrow G, the wiper and frame are displaced away from the container 910 in the direction of arrow H. Preferably, movement of the wiper 960 and the frame 950 is a result of contact between a cam follower (not shown) and the outer surface of a neck 915 of the container 910. At this particular stage of the labeling operation, displacement of the wiper 960 and frame 950 in the direction of arrow H generally occurs prior to arrival of the container 910 as indicated by a center 902 of the container 910 being upstream of the frame 950 in FIG. 42. The center 902 is the geometric center of the container 910 and is defined by the intersection of container-bisecting planes 902x and 902y. FIG. 42 also depicts a preferred configuration for the distal end or chute 936 of the label dispenser 935. In this preferred orientation of the chute 936, the label 920 exits the dispenser 935 in a direction that is parallel or at least substantially so to a line tangent with a face of the container 910 directed toward the wiper and frame, and contacting the container 910 at the intersection thereof by plane 902y. This tangential line is illustrated in FIG. 42 as dashed line z.

Referring to FIG. 43, as the container 910 continues to approach the wiper and frame, the cam follower starts to allow the wiper 960 to move toward the container 910. The wiper then starts to direct the label toward the container. Specifically, the container 910 continues to move toward the assembly of the wiper member 960 and the frame 950 in the direction of arrow G. As a result of the shape of the cam surface of the cam follower (not shown), the frame 950 is then displaced toward the moving container 910 in the direction of arrow I shown in FIG. 43. Movement in the direction of arrow I continues so that a contacting region 966 of the wiper member 960 contacts the label 920 and displaces the label 920 toward the container 910. At this stage in the process, the center 902 of the container is approaching the chute 936 of the label dispenser 935.

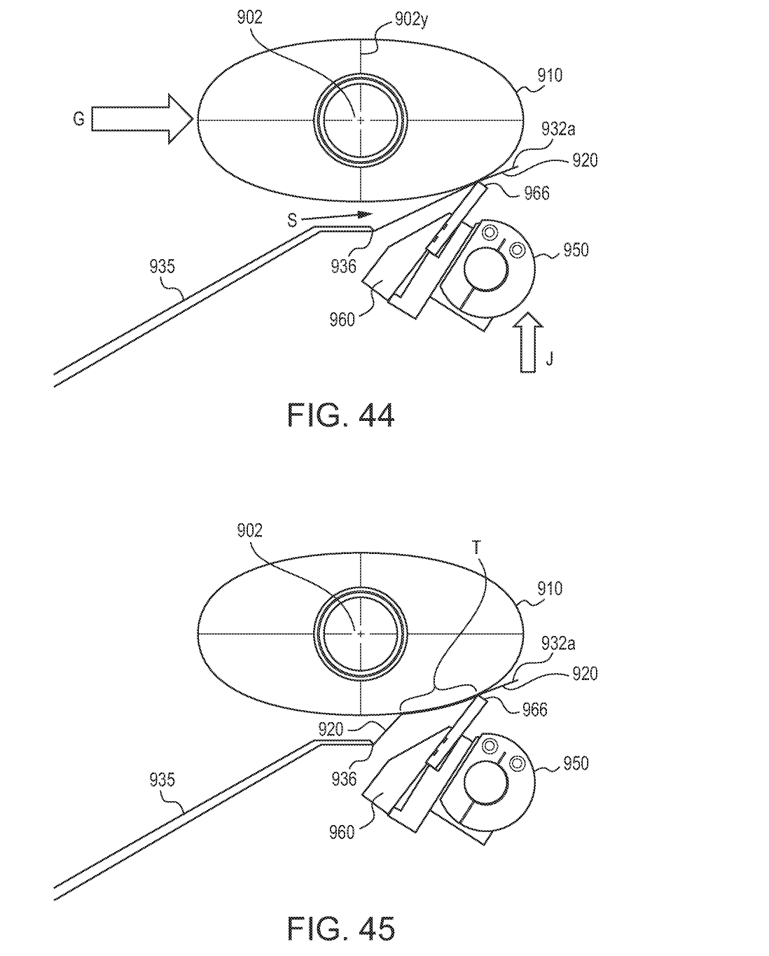

Referring to FIG. 44, the wiper 960 places the label on the container in a position that is determined by the shape of the cam follower (not shown). This action creates a label flag and controls the length of the flag. It is significant that the label is applied to the container by the wiper to eliminate or avoid the formation of bubbles in the label. If the label is applied to the container before the wiper applies such, then an undesirable pre-tack condition can occur which will often involve bubbles. Specifically, in FIG. 44, the assembly of the wiper member 960 and the frame 950 is further displaced toward the moving container 910 in the direction of arrow J. This results in the contacting region 966 of the wiper member 960 contacting the label 920 to the container 910. It will be noted that such contact is made so that a leading edge of the label remains free of contact with the container 910, thereby creating a label flag 932a. At this stage of the labeling process the center 902 of the container is approximately adjacent to the chute 936 of the label dispenser 935.

FIG. 45 illustrates an example of undesirable condition of pre-tack. In this condition, contact occurs between the label 920 and the container 920 upstream of the contacting region 966 of the wiper member 960. As explained, this typically leads to the formation of air bubbles under the label 920 within the region of the label denoted as T.

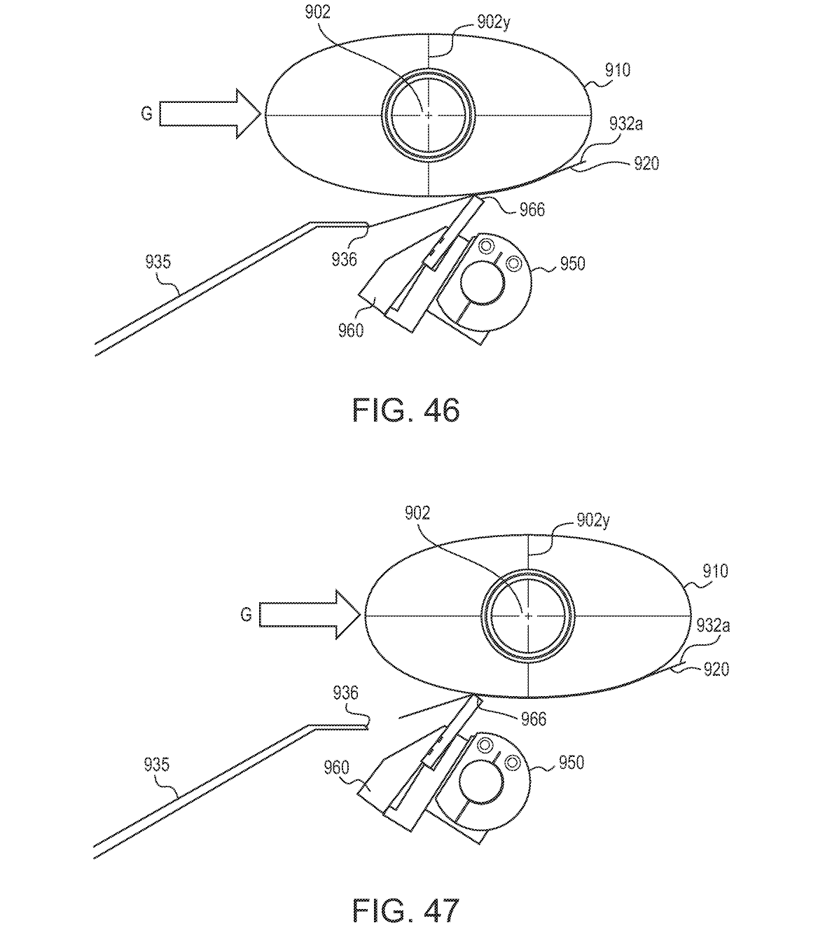

In FIG. 46, the wiper moves along the container, thereby wiping the label onto the container. Specifically, at this stage of the labeling operation, the center 902 of the container 910 is now downstream of the chute 936 of the label dispenser 935. The container continues to move in the direction of arrow G. Another preferred practice in accordance with the invention is to adjust the rate at which the label 920 is administered from the label dispenser 935 such that the label 920 is slightly tensioned or pulled from the label dispenser as a result of the label contacting the moving container 910 at this juncture of the process. This practice has been discovered to promote bubble-free application of labels to containers.

Referring to FIG. 47, the label separates from and completely exits the chute 936. The wiper continues wiping the label 920 onto the container. Specifically, as the container continues moving in the direction of arrow G, the label 920 is contacted with the container 910 and wiped by the wiper member 960. At this stage of the labeling operation, the center 902 of the container is downstream of the wiper 960 and the frame 950.

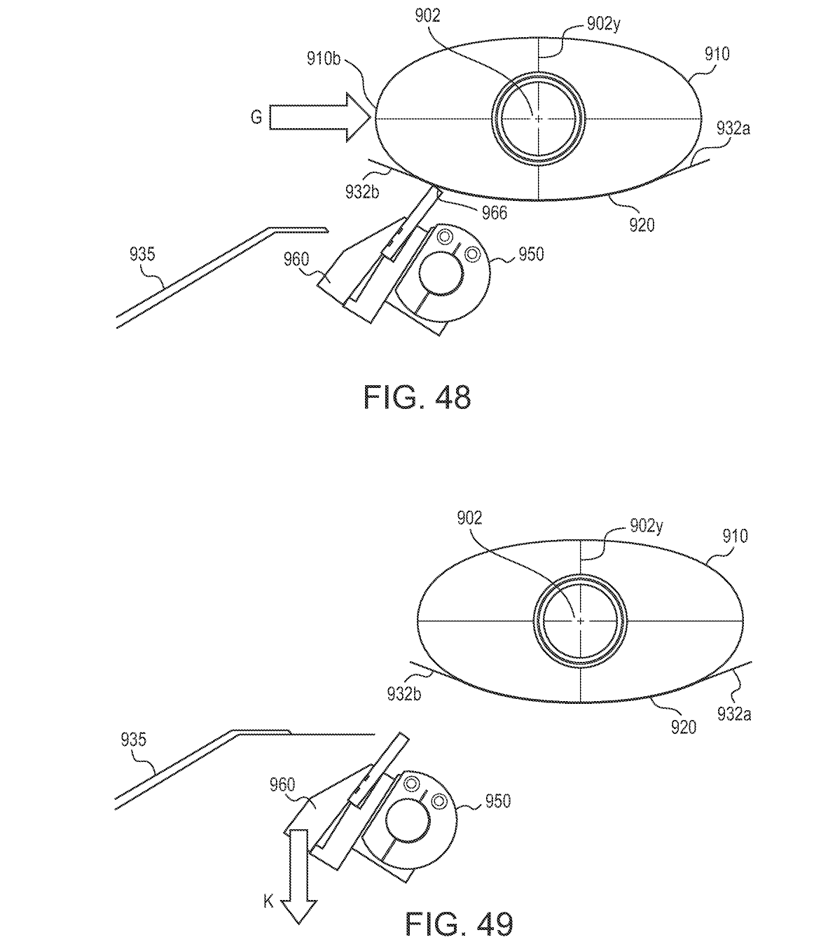

Referring to FIG. 48, the wiper finishes wiping the label onto the container but the wiper does not fully wipe down the trailing label edge. This leaves a trailing flag. The stroke of the wiper limits the wiper from further contacting the container so the flag is created. It is contemplated that by varying the cam configuration, the wiper can be separated from the container so that the length of the trailing flag can be controlled. More specifically, at the stage of labeling depicted in FIG. 48, movement of the container 910 is continued in the direction of arrow G. The label 920 is now partially applied to the container 910 such that a leading flag 932a and a trailing flag 932b exist. At this stage of the process, the contacting region 966 of the wiper member 960 is positioned downstream of the container center 902 and between the center 902 and a trailing face 910b of the container 910.

In FIG. 49, the wiper starts to move away from the path of the moving container 910 so that the process starts over for the next container. That is, the wiper member 960 and the frame 950 are displaced away from the container 910 in the direction of arrow K. This process is repeated for another container (not shown) upstream and following the container 910.

It will be understood that in no way is the present invention limited to any of the labeling practices described and shown herein. Although not wishing to be limited to any particular practice, generally a preferred practice is as follows. A label is initially contacted with a container along an upstream or leading edge or region of the label. The edge or region need not include the leading-most portion of the label but is generally defined proximate the leading-most label portion. The leading-most label portion is not in contact with the container and thus constitutes a flag. The region of the container corresponding to and underlying the leading-most flag is typically compoundly curved. The flag can be fully contacted and applied to the compoundly curved region of the container in a later operation by a heated flexible member for example.

The container carrying the partially applied label moves past the wiping assembly as described herein. The wiping assembly then further contacts the label to the container by the selective wiping operation described herein. Preferably, wiping is terminated such that a trailing-edge flag is left which is not in contact with an underlying container region, which as noted is typically compoundly curved. The trailing-edge flag can be fully contacted and applied to the compoundly curved region of the container in a later operation by a heated flexible member for example.

It is also contemplated that other components such as pneumatic or hydraulic actuators or electrical servo motors could be used to selectively position one or more components to achieve additional label and container configurations. For example, instead of using a pivoting arrangement for the frame 850, a track system and one or more servo motors could be used to selectively position the wiper member 860 into position for wiping a label and out of position to allow the container and/or label flags to pass without interference from the wiper member 860.

The present invention also provides various methods for selectively contacting a label, for example to selectively wipe the label or portions thereof, that is carried on a moving container. The methods generally comprise providing a moveable cam member and a moveable frame assembly. The cam is configured such that its movement corresponds to movement of the container and the label carried on the container. The frame is preferably pivotally moveable about a vertical pivot axis. A wiper member is affixed or otherwise engaged to the moveable frame. The frame is located relative to the path of the moving container such that as the frame is pivoted, the wiper member is moved between two positions. In one of the positions, the wiper member is in contacting proximity of the path of the container. And in another position, the wiper is located a distance away from the path of the container. The term “contacting proximity” as used herein with regards to the wiper member, refers to that member being in a position such that a distal edge or end region of the wiper member contacts a label carried on a container as the container moves past the wiper member.

In a preferred method, a cam follower is provided in association with the moveable frame. The frame is positioned and oriented such that the cam follower is in operable engagement with the cam member. Most preferably, the cam, the cam follower, and movement of the container are tied to one another such that the frame is pivoted about the pivot axis such that when the moving container is alongside the frame, the wiper is in contacting proximity with the container so that the wiper contacts the label carried on the container. As the container moves past the frame, the frame is pivoted about the pivot axis such that the wiper member is displaced or moved away from the path of the moving container.

And, methods are provided for selectively contacting a label as noted herein in which the containers themselves serve as the cam member. The methods involve providing a cam follower that is operated by a collection of containers moving alongside the cam follower. Periodic contact between the cam follower and the containers, such as container necks, can be used to govern the movement of the wiper member.

It will be appreciated that the present invention includes variations of this method and provides an array of techniques for selectively contacting a label or portions of a label that is carried on a moving container.

A wide array of labels, films, and/or assemblies of such can be selectively applied to a container using the various equipment, systems, and methods described herein. For example, examples of typical materials use for labels or label substrates include but are not limited to paper, polyester (Mylar), polyethylene and the like. As noted, the label or film may be in the form of a heat shrink film. The shrink film useful in the label may be a single layer construction or a multilayer construction. The layer or layers of the shrink film may be formed from a polymer chosen from polyester, polyolefin, polyvinyl chloride, polystyrene, polylactic acid, copolymers and blends thereof. Generally, any of the labels or film, adhesives, and additional aspects thereof previously noted herein in conjunction with the use of flexible members can be used in conjunction with the label application systems and strategies using wiping members. The present invention can be used for applying a wide array of labels, film, and other members. For example, the invention can be used in conjunction with shrink labels, pressure sensitive labels, pressure sensitive shrink labels, heat seal labels, and nearly any type of label or film known in the packaging and labeling arts. Labels applied using the equipment, systems, and/or methods described herein preferably exhibit several characteristics or aspects as follows. The label is generally sized such that upon fully contacting or adhering the label to the container, the label does not extend about the entire periphery of the container. Most preferably, upon full contact with a container, the edges or other regions of a label do not overlap with other edges or regions of the same label.

The invention also provides various labeling systems for producing a labeled container. These systems comprise a label dispenser for selectively positioning a label alongside a moving container, a label or plurality of labels, and an assembly for selectively contacting one or more regions of a label positioned alongside a container by the label dispenser. The assembly comprises a moveable frame, the frame including at least one frame member pivotally moveable about a pivot axis. The assembly further comprises a wiper member engaged to the frame member and moveable therewith. The wiper member includes a wiping element for contacting the label. The assembly also comprises a cam follower affixed to the frame and moveable therewith. Movement of the cam follower corresponds to movement of a container, whereby the wiping element selectively contacts the label onto the moving container.

### Post Heat Treatment

As explained in greater detail herein, various methods and systems are provided for post treating a label or film previously adhesively applied to a container or other substrate. The methods generally include heating the applied label or label assembly to a particular temperature relatively quickly, and generally directly after label application. Preferably, during this heating operation, the adhesive disposed between the label and the surface of the container or substrate is also heated in like fashion as the label. The term “adhesively applied” as used herein with regard to labels, refers to labels that are applied and retained along exposed surfaces of containers or substrates by one or more layers of adhesive(s). Applied labels treated in accordance with the particular methods described herein exhibit reduced defect rates, improved label retention and adherence, and better aesthetics as compared to corresponding applied labels not subjected to the methods.

In particular, the present invention provides further advances in strategies and methods for applying labels and films onto curved surfaces such as outer curved surfaces of various containers. Although the present invention is described in terms of treatment strategies for labels or films that have previously been applied to containers, it will be understood that the invention is not limited to containers. Instead, the invention can be used to post-treat a variety of labels or films previously applied onto surfaces of nearly any type of article. The invention is particularly directed to treating shrink labels that have previously been applied onto curved container surfaces. And, the invention is also particularly directed to treating labels such as shrink labels that have been applied onto compound curved surfaces of various containers.

It is to be understood that the present invention can be used for treating labels and films that have been applied onto a wide variety of surfaces, including planar surfaces and simple curved surfaces. However, as explained in greater detail herein, the invention is particularly well suited for post treatment of labels and films and their associated adhesive(s) that have been applied onto compound curved surfaces.

Generally, in accordance with the preferred methods, heat is applied to one or more previously applied labels on containers at a particular time in a labeling operation and within a certain time period in order to thermally anneal the label film material after the label has been applied to the container. Preferably, the adhesive disposed between the label and the receiving surface is also heated to the same extent or substantially so as the label. The particular temperatures to which the applied labels are heated have been discovered to minimize label defects that otherwise typically occur upon aging such as darts, wrinkles, bubbles, lifts, etc. Such defects occurring after label application are generally and collectively referred to herein as “post-defects”.

And, depending upon the particular labeling process, the post heating treatment methods may also enable one or more preheating operations to be eliminated. For labels including heat shrink materials, the preferred post application heating is performed after heat shrinking of the label. Heat can be applied to labeled containers in a variety of methods such as by use of infrared lamps, radiant heaters, hot forced air ovens, shrink tunnels . . . etc. The amount of heat is generally determined by the characteristics of the label material, the speed of the labeling process and the amount of heat already imparted into the label prior to the post heat section. For labels including heat shrink materials, the amount of heat also is determined by the shrink temperature of the material. Nearly any type of container having a label applied thereto can receive the treatment techniques described herein. All of these aspects are described in greater detail herein.

### Preferred Treatment Methods

The preferred treatment methods involve heating a previously applied label and adhesive to a particular temperature, and at a specific time within or after a labeling operation. Preferably, the applied label and adhesive are at ambient temperature or approximately so, and are heated to a temperature of from about 30° C. to about 150° C. and more preferably, heated to a temperature of from about 50° C. to about 100° C. Generally, heating of the applied label occurs quickly, such as typically in less than 5 seconds, preferably less than 3 seconds, and most preferably less than 1 second. The use of such rapid heating times enables the treatment methods described herein to be utilized in high speed labeling operations.

In practice, achieving these particular temperatures in an applied label can be accomplished by exposing the applied label assembly to an environment having a temperature of at least 100° C. or higher. Heating may be performed by any suitable method. Generally, heating can be performed by one or more heat transfer mechanisms such as conductive heating, convective heating, radiant heating, or combinations thereof. A wide array of heating equipment or devices can be used to heat the applied labels and associated adhesives. Non-limiting examples include, but are not limited to, infrared lamps, radiant heaters, hot forced air ovens, heated chambers, heated tunnels, heated contact surfaces, and the like. Preferably, heating is performed using radiant heaters in a chamber or hot air guns in a chamber, either with infrared (IR) sensors to measure the temperature of the label upon exit. Heating devices are well known in the art and readily available.

Preferably, the treatment process involves heating the label and adhesive layer immediately after application to a container or substrate. The term “immediately” as used herein generally refers to initiating heating of a label after application without delay such that heating occurs following label application. In practical terms, heating occurs preferably in less than 5 seconds after label application and most preferably less than 1 second after label application. However, it will be appreciated that the invention includes heating performed subsequent to label application, such as after a time period of a minute or more, and in certain applications even after a period of several hours after label application. Furthermore, it is contemplated that the heating techniques described herein could be performed well after label application such as up to 24 hours after label application. The particular temperatures and times largely depend upon the materials used in the label or film, characteristics of the label, and the adhesive.

Applied labels and adhesives treated in accordance with the particular methods described herein exhibit reduced defect rates, improved label retention and adherence, and better aesthetics as compared to corresponding applied labels not subjected to the methods. Specifically, labels subjected to the treatment techniques described herein, tend to remain in their as-applied state and do not become wrinkled, form darts, or exhibit lifting or separation along their edges or the interface between label and receiving surface. Accordingly, labels and adhesives subjected to the treatment techniques of the invention exhibit improved retention such as characterized by longer retention periods and overall stronger adherence to an underlying surface as compared to corresponding labels not subjected to the treatment techniques noted herein. The absence of defects such as wrinkles, darts, bubbles, and/or lifts, results in an improved appearance and a more aesthetically appealing label. These characteristics are desirable from a commercial perspective and particularly when the label is on a container on display in a retail environment.

Although not wishing to be bound to any particular theory, it is believed that various internal stresses within the polymeric label or film material are generated or increased during label manufacture and particularly during label application. Internal stresses in film materials are particularly pronounced during heat shrinking and/or application of heat shrink labels. Although the relatively permanent bonds provided by the label adhesive serve to retain the label in its initial as-applied state, internal stresses in the label material can result in subsequent distortion of the label and movement from its as-applied position. These effects are typically exhibited as label defects in the form of wrinkles, darts, and the like. Thus, in accordance with the invention, methods and systems for preventing label post-defects are provided. Generally, the methods involve comprising providing a substrate such as a container, having a polymeric label adhesively applied thereon. The methods also comprise, after application of the label and preferably immediately after adhesive application of the label, heating the applied label to a temperature that is sufficient to relieve at least a portion of the internal stresses in the label material, and thereby prevent or at least reduce label post-defects that would otherwise occur.

In accordance with the preferred embodiment methods described herein, it has been discovered that heating an applied label to a particular temperature and at a particular point in a labeling operation can sufficiently relieve stresses in the label material(s) such that the noted label defects do not otherwise occur. As noted, labels applied onto curved container surfaces and especially compound curved container surfaces, are prone to exhibit such defects. It is surprising and unexpected that these defects can be eliminated by the heating techniques described herein. Furthermore, the particular heating operations are performed such that no dimensional changes occur in the label. This is significant when using heat shrink materials. Moreover, the post-heating operations described herein can, if implemented in certain labeling operations, eliminate the need for one or more preheating stages typically used in known labeling processes.

### Systems for Reducing Label Post-Defects

The present invention also provides various systems and related equipment assemblies for performing the noted methods and techniques described herein. Preferably, the systems serve to reduce and ideally, eliminate label post-defects. The systems generally comprise an assembly for adhesively applying a label to a container. Examples of label application assemblies are provided in one or more of the following US patents or published US patent applications: 4,192,703; 4,561,928; 4,724,029; 5,785,798; 7,318,877; 2005/0153427; and 2007/0113965. It will be understood that in no way is the present invention system limited to the use of one or more of these representative labeling assemblies. Instead, the present invention system for reducing label post-defects can use nearly any type of labeling equipment. The systems in accordance with the invention also comprise one or more heaters for heating the applied label immediately after adhesive application of the label to the container. The one or more heaters are preferably capable of heating the applied labels from ambient temperature to a temperature of from about 30° C. to about 150° C. within a time period of less than about 5 seconds. It will be appreciated that the present invention systems can use heaters that perform the noted heating of applied labels in time periods longer than 5 seconds. Examples of suitable heaters are those previously noted herein. Preferably, the systems and more particularly, the heaters are capable of heating the noted labels to a temperature of from about 50° C. to about 100° C. Preferably, the systems and more particularly, the heaters are capable of heating the noted labels to the indicated temperatures within a time period of less than 3 seconds and most preferably, within a time period of less than 1 second. Preferably, the heaters are radiant heaters. However, as noted herein, a wide array of heating devices can be used. The systems may also comprise one or more temperature sensors such as infrared (IR) sensors to conveniently and accurately measure the temperature of the label during and after the heating operation.

### EXAMPLES

Containers were labeled with polypropylene labels at a temperature below which the labeled containers would typically remain defect-free. All labels were applied without defects at the time of application. Labeled containers were then immediately placed in a 100° C. oven for various dwell times. The final temperature of the labels was measured at the end of the oven aging. Containers were then inspected after 1 week aging at room temperature.

A control sample that was not exposed to a post-heat treatment failed within 1 week due to defect formation. All samples that were exposed to at least 30 seconds of 100° C. post heat (squares) passed inspection after 1 week aging. Based upon these results, it is believed that an exit temperature of at least 50° C. is sufficient in the post heat step to prevent defects of this particular label material.

Although the various treatment processes described herein have been described in conjunction with eliminating one or more heating steps prior to or during label application, it will be appreciated that the present invention also includes the use of the treatment processes utilized in conjunction with labeling operations that employ heating. Thus, the treatment processes described herein are contemplated for a host of labeling operations.

Although the present invention and its various preferred embodiments have been described in terms of applying labels, and particularly pressure sensitive shrink labels, onto curved surfaces of containers, it will be understood that the present invention is applicable to applying labels, films, or other thin flexible members upon other surfaces besides those associated with containers. Moreover, it is also contemplated that the invention can be used to apply such components onto relatively flat planar surfaces.

Additional details associated with applying pressure sensitive labels, and particularly pressure sensitive shrink labels, are provided in WO 2008/124581; US 2009/0038736; and US 2009/0038737.

Many other benefits will no doubt become apparent from future application and development of this technology.

All patents, published applications, and articles noted herein are hereby incorporated by reference in their entirety.

As described hereinabove, the present invention solves many problems associated with previous type devices and methods. However, it will be appreciated that various changes in the details, materials and arrangements of parts or operations, which have been herein described and illustrated in order to explain the nature of the invention, may be made by those skilled in the art without departing from the principle and scope of the invention, as expressed in the appended claims.

1. A label processor for concurrently heating and contacting a label to a container, the processor comprising:
a rigid frame defining a first face and an oppositely directed second face, the frame defining an opening extending between the first and the second faces;
a flexible member disposed adjacent to at least one of the first face and the second face of the frame and extending through the opening of the frame and projecting outward from the second face of the frame, the flexible member defining an outer surface for contacting a label, the flexible member defining an interior hollow region accessible from the first face of the frame, the flexible member being deformable upon application of a label contacting force to a portion of the member projecting outward from the second face of the frame.

2. The label processor of claim 1 further comprising:
a heat source disposed within the interior hollow region of the flexible member for heating the outer surface of the flexible member.

3. The label processor of claim 1 wherein the interior hollow region of the flexible member is at least partially enclosed to restrict communication between the interior region of the member and a region external to the member.

4. The label processor of claim 1 wherein upon deformation of the flexible member causing a reduction in the volume of the interior hollow region of the flexible member, the pressure within the interior region increases.

5. The label processor of claim 2 wherein the heat source heats the outer surface of the flexible member to a temperature of at least 38° C.

6. The label processor of claim 5 wherein the temperature is from 120° C. to 150° C.

7. The label processor of claim 2 wherein the heat source includes a fluid that is heated at a location external to the flexible member and then transferred into the interior hollow region of the flexible member.

8. The label processor of claim 7 wherein the fluid is selected from the group consisting of oil and air.

9. The label processor of claim 8 wherein the fluid is air, the label processor further comprising:
a manifold disposed within the interior hollow region of the flexible member, the manifold in flow communication with the heated external air.

10. The label processor of claim 9 wherein the manifold includes a conduit defining a longitudinally extending interior flow channel and a plurality of apertures in a sidewall of the conduit providing flow communication between the conduit interior and the interior hollow region of the flexible member.

11. The label processor of claim 2 wherein the heat source includes an electrically powered resistive heater disposed in the interior hollow region of the flexible member.

12. The label processor of claim 1 wherein the flexible member includes a silicone material.

13. The label processor of claim 1 wherein the flexible member exhibits an average thickness of from about 2.3 mm to about 3.0 mm.

14. The label processor of claim 1 wherein the flexible member defines a longitudinal axis and is shaped so as to be symmetrical about the longitudinal axis.

15. The label processor of claim 1 wherein the frame includes at least one guide extending from the second face of the frame, the at least one guide extending at least partially alongside a lateral region of the flexible member.

16. The label processor of claim 1 wherein the frame includes a first guide and a second guide extending from the second face of the frame, the first and second guides separated by at least a portion of the opening.

17. The label processor of claim 1 wherein the flexible member is disposed between the first and second guides, the first and second guides serving to limit the extent of laterally outward deformation of the flexible member upon application of the label contacting force to the flexible member.

18. The label processor of claim 1 wherein the first and second guides are oriented parallel to one another.

19. The label processor of claim 16 wherein the first and second guides extend transversely from the second face of the frame.

20. The label processor of claim 16 wherein at least one of the first guide and the second guide includes an inner side having at least one of a concave region and convex region.

21. The label processor of claim 16 wherein at least one of the first guide and the second guide is selectively positionable relative to the frame.

22. The label processor of claim 21 wherein the frame includes at least one vertically extending rail to which at least one of the first and the second guides is releasably engaged therewith thereby enabling the at least one guide to be selectively positionable relative to the frame.

23. The label processor of claim 16 wherein the first and second guides each define an inner face, wherein the shape of the inner faces correspond to that of a container to receive a label by the label processor.

24. The label processor of claim 16 wherein the first guide defines a distal end region spaced from the second face of the frame, the first guide including a wing member affixed to the distal end region of the first guide, the wing member serving to further limit the extent of outward deformation of the flexible member.

25. The label processor of claim 24 wherein the wing member affixed to the first guide is a first wing member, the second guide defines a distal end region spaced from the second face of the frame, the second guide including a second wing member affixed to the distal end region of the second guide, the second wing member also serving to further limit the extent of outward deformation of the flexible member.

26. The label processor of claim 24 wherein the wing affixed to the first guide is positionable such that the extent of outward deformation of the flexible member can be varied.

27. The label processor of claim 1 wherein the flexible member further includes:
a base in contact with at least one of the first face and the second face of the frame;
a plurality of side walls projecting from the base; and
a domed surface, wherein the domed surface includes the outer surface for heating and contacting a label;
wherein the plurality of side walls extend between the base and the domed surface and are integrally formed with the base and the domed surface.

28. The label processor of claim 1 wherein the opening of the frame defines four edges, and the flexible member includes four side walls, each side wall positioned alongside a corresponding edge.

29. The label processor of claim 1 wherein the side walls are arranged such that a first side wall and a second side wall are parallel to one another and extend between a third side wall and a fourth side wall, the third and the fourth side walls also being parallel to one another.

30. A process for applying a label to an article, the process comprising:
providing a label processor including (i) a rigid frame defining a first face and an oppositely directed second face, and (ii) a flexible member projecting outward from the second face of the frame, the flexible member defining an outer surface for heating and contacting a label, the flexible member defining an interior hollow region accessible from the first face of the frame;
heating the outer surface of the flexible member;
providing an article and a label at least partially contacted thereto, wherein portion(s) of the label contacting the article define attached region(s) and portion(s) of label free from contact with the article define unattached region(s);
progressively contacting the label with the heated outer surface of the flexible member such that the flexible member first contacts an attached region of the label and subsequently contacts and heats an unattached region to thereby fittingly apply the unattached region of the label to a complex curved surface of the article.

31.-40. (canceled)

41. An assembly for applying labels to a plurality n of containers, the assembly comprising:
a plurality n of label processors, each processor including (i) a rigid frame defining a first face and an oppositely directed second face, (ii) a flexible member projecting outward from the second face of the frame, the flexible member defining an outer surface for heating and contacting a label, the flexible member defining an interior hollow region accessible from the first face of the frame and (iii) a heat source disposed within the interior hollow region of each flexible member.

42. (canceled)

43. A label processing system for contacting a label to a container, the system comprising:
a label processor for concurrently heating and contacting a label to a container, the process or including:
a rigid frame defining a first face and an oppositely directed second face, the frame defining an opening extending between the first and the second faces;
a flexible member disposed adjacent to at least one of the first face and the second face of the frame and extending through the opening of the frame and projecting outward from the second face of the frame, the flexible member defining an outer surface for contacting a label, the flexible member defining an interior hollow region accessible from the first face of the frame, the flexible member being deformable upon application of a label contacting force to a portion of the member projecting outward from the second face of the frame;
a label for heating and contacting to a container by the processor.

44.-47. (canceled)

48. An assembly for selectively contacting one or more regions of a label to a moving container, the assembly comprising:
a moveable frame, the frame including at least one frame member pivotally moveable about a pivot axis;
a wiper member engaged to the frame member and moveable therewith, the wiper member including a wiping element for contacting a label;
a cam follower affixed to the frame and moveable therewith;
wherein movement of the cam follower corresponds to movement of a container and label to be contacted by the wiping element, whereby the wiping element selectively contacts the label to the moving container.

49.-67. (canceled)

68. A system for partially applying a label to a moving container, the system comprising:
a conveyor for transporting containers equally spaced and aligned thereon;
a wiping assembly disposed proximate to the conveyor, the wiping assembly including:
a moveable frame, the frame pivotally moveable about a pivot axis;
a wiper member affixed to the frame and positionable such that the wiper member can be placed into contacting proximity with a container transported by the conveyor by selectively pivoting the frame;
a cam follower affixed to the frame and operated such that movement of the conveyor results in reciprocating pivotal movement of the cam follower, the frame, and the wiper member;
wherein the cam follower is configured such that as a container on the conveyor is transported to the wiping assembly and proximate therewith, the wiper member is positioned so as to contact a label positioned between the container and the wiper member and apply a force to the label to thereby further contact the label with the container, however leaving at least one label flag.

69.-86. (canceled)

87. A labeling system for producing a labeled container, the system comprising:
a label dispenser adapted to selectively position a label alongside a moving container;
a label for administration by the label dispenser;
an assembly for selectively contacting one or more regions of a label positioned alongside a container by the label dispenser, the assembly comprising:
a moveable frame, the frame including at least one frame member pivotally moveable about a pivot axis;
a wiper member engaged to the frame member and moveable therewith, the wiper member including a wiping element for contacting the label;
a cam follower affixed to the frame and moveable therewith;
wherein movement of the cam follower corresponds to movement of a container, whereby the wiping element selectively contacts the label onto the moving container.

88.-91. (canceled)

92. A method of selectively contacting a label to a moving container, the method comprising:
providing a moveable frame assembly, the frame including at least one frame member pivotally moveable about a pivot axis;
affixing a wiper member to the frame;
positioning the frame such that upon pivoting the frame about the pivot axis, the wiper member is displaced between (i) a first position in which the wiper member is in contacting proximity of a path of the moving container, and (ii) a second position in which the wiper member is spaced from the path of the moving container;
providing a cam follower on the frame assembly;
positioning a label between the container and the wiper member; and
configuring the cam follower and movement of the container such that the frame is pivoted so that when the moving container is alongside the wiper member, the wiper member is displaced to the first position so that the wiper member contacts the label to the container.

93.-99. (canceled)

100. A method for preventing label post-defects, the method comprising:
providing a substrate having a polymeric label adhesively applied to the substrate;
immediately after adhesive application of the label to the substrate, heating the label to a temperature sufficient to relieve at least a portion of internal stresses within the polymeric label material and thereby prevent label post-defects.

101.-107. (canceled)

108. A method for improving label retention after adhesive application to a substrate, the method comprising:
immediately after adhesive application of a label to a substrate, heating the label and adhesive to a temperature of at least 30° C.

109.-122. (canceled)

123. A method for preventing label defects in a label applied onto a container, the method comprising:
providing a container having an exterior surface;
providing a label;
adhesively applying the label to the exterior surface of the container by use of an effective amount of adhesive disposed between the label and the exterior surface of the container; and
immediately after application of the label to the exterior surface of the container, heating the applied label and the adhesive to a temperature of at least 30° C. within a time period less than 5 seconds.

124.-134. (canceled)

135. A method for reducing label defects occurring after application of an adhesively applied label to an exterior surface of a container, the method comprising:
immediately after application of the label to the exterior surface of the container, heating the label and the adhesive to a temperature of from about 50° C. to about 100° C. within a time period of from less than 5 seconds.

136.-143. (canceled)

144. A system for reducing label post-defects, the system comprising:
an assembly for adhesively applying a label to a container; and
a heater for heating the applied label immediately after application to the container, the heater being capable of heating the applied label to a temperature of from about 30° C. to about 150° C., within a time period of less than 5 seconds.

145.-150. (canceled)
